(19) United States
(12) Patent Application Publication
(10) Pub. No.: US 2009/0182791 A1
(43) Pub. Date: Jul. 16, 2009

(54) Non-Volatile Memories And Method With Adaptive File Handling In A Directly Mapped File Storage System

(76) Inventor: Sergey Anatolievich Gorobets, Edinburgh (GB)

Correspondence Address: DAVIS WRIGHT TREMAINE LLP - SANDISK CORPORATION, 505 MONTGOMERY STREET, SUITE 800, SAN FRANCISCO, CA, 94111, US

(21) Appl. No.: 12/405,140

(22) Filed: Mar. 16, 2009

Related U.S. Application Data
(63) Continuation of application No. 11/316,239, filed on Dec. 21, 2005.

(51) Int. Cl. G06F 12/00; G06F 12/02

(52) U.S. Cl. 707/205; 707/E17.01; 707/E17.044; 711/E12.001; 711/E12.002

(57) ABSTRACT

In a memory system with a file storage system, an optimal file handling scheme is adaptively selected from a group thereof based on the attributes of the file being handled. The file attributes may be obtained from a host or derived from a history of the file had with the memory system. In one embodiment, a scheme for allocating memory locations for a write operation is dependent on an estimated size of the file to be written. In another embodiment, a scheme for allocating memory locations for a relocation operation, such as for garbage collection or data compaction, is dependent on an estimated access frequency of the file in question. In this way, the optimal handling scheme can be used for the particular file at any time.

### CROSS REFERENCE TO RELATED APPLICATION

This application is a continuation of application Ser. No. 11/316,239, filed on Dec. 21, 2005, This application is also related to an application Ser. No. 11/316,110, filed on Dec. 21, 2005, by Sergey Anatolievich Gorobets, entitled “Non-volatile Memories With Adaptive File Handling in a Directly Mapped File Storage System,” which applications are incorporated herein in their entirety by this reference.

### GENERAL BACKGROUND

This application relates to the operation of re-programmable non-volatile memory systems such as semiconductor flash memory, and, more specifically, to memories implementing a direct file system. All patents, patent applications, articles and other publications, documents and things referenced herein are hereby incorporated herein by this reference in their entirety for all purposes.

There are two primary techniques by which data communicated through external interfaces of host systems, memory systems and other electronic systems are addressed. In one of them, addresses of data files generated or received by the system are mapped into distinct ranges of a continuous logical address space established for the system. The extent of the address space is typically sufficient to cover the full range of addresses that the system is capable of handling. In one example, magnetic disk storage drives communicate with computers or other host systems through such a logical address space. This address space has an extent sufficient to address the entire data storage capacity of the disk drive. In the second of the two techniques, data files generated or received by an electronic system are uniquely identified and their data logically addressed by offsets within the file. A form of this addressing method is used between computers or other host systems and a removable memory card known as a “Smart Card.” Smart Cards are typically used by consumers for identification, banking, point-of-sale purchases, ATM access and the like.

These two different addressing techniques are not compatible. A system using one of them cannot communicate data with a system using the other. The descriptions below provide examples of data communication between host and memory systems where the host system utilizes a logical address space interface. The example memory system that is described is re-programmable non-volatile semiconductor flash memory.

In an early generation of commercial flash memory systems, a rectangular array of memory cells was divided into a large number of groups of cells that each stored the amount of data of a standard disk drive sector, namely 512 bytes. An additional amount of data, such as 16 bytes, are also usually included in each group to store an error correction code (ECC) and possibly other overhead data relating to the user data and/or to the memory cell group in which it is stored. The memory cells in each such group are the minimum number of memory cells that are erasable together. That is, the erase unit is effectively the number of memory cells that store one data sector and any overhead data that is included. Examples of this type of memory system are described in U.S. Pat. Nos. 5,602,987 and 6,426,893. It is a characteristic of flash memory that the memory cells need to be erased prior to re-programming them with data.

Flash memory systems are most commonly provided in the form of a memory card or flash drive that is removably connected with a variety of hosts such as a personal computer, a camera or the like, but may also be embedded within such host systems. When writing data to the memory, the host typically assigns unique logical addresses to sectors, clusters or other units of data within a continuous virtual address space of the memory system. Like a disk operating system (DOS), the host writes data to, and reads data from, addresses within the logical address space of the memory system. A controller within the memory system translates logical addresses received from the host into physical addresses within the memory array, where the data are actually stored, and then keeps track of these address translations. The data storage capacity of the memory system is at least as large as the amount of data that is addressable over the entire logical address space defined for the memory system.

In later generations of flash memory systems, the size of the erase unit was increased to a block of enough memory cells to store multiple sectors of data. Even though host systems with which the memory systems are connected may program and read data in small minimum units such as sectors, a large number of sectors are stored in a single erase unit of the flash memory. It is common for some sectors of data within a block to become obsolete as the host updates or replaces logical sectors of data. Since the entire block must be erased before any data stored in the block can be overwritten, new or updated data are typically stored in another block that has been erased and has remaining capacity for the data. This process leaves the original block with obsolete data that take valuable space within the memory. But that block cannot be erased if there are any valid data remaining in it.

Therefore, in order to better utilize the memory's storage capacity, it is common to consolidate or collect valid partial block amounts of data by copying them into an erased block so that the block(s) from which these data are copied may then be erased and their entire storage capacity reused. It is also desirable to copy the data in order to group data sectors within a block in the order of their logical addresses since this increases the speed of reading the data and transferring the read data to the host. If such data copying occurs too frequently, the operating performance of the memory system can be degraded. This particularly affects operation of memory systems where the storage capacity of the memory is little more than the amount of data addressable by the host through the logical address space of the system, a typical case. In this case, data consolidation or collection may be required before a host programming command can be executed. The programming time is then increased.

The sizes of the blocks are increasing in successive generations of memory systems in order to increase the number of bits of data that may be stored in a given semiconductor area. Blocks storing 256 data sectors and more are becoming common. Additionally, two, four or more blocks of different arrays or sub-arrays are often logically linked together into metablocks in order to increase the degree of parallelism in data programming and reading. Along with such large capacity operating units come challenges in operating them efficiently.

A common host interface for such memory systems is a logical address interface similar to that commonly used with disk drives. Files generated by a host to which the memory is connected are assigned unique addresses within the logical address space of the interface. The memory system then commonly maps data between the logical address space and the physical blocks or metablocks of the memory. The memory system keeps track of how the logical address space is mapped into the physical memory but the host is unaware of this. The host keeps track of the addresses of its data files within the logical address space but the memory system operates without knowledge of this mapping.

The logical address interface was originally design for disk operating systems. It is not optimized for flash memory that employs erasable blocks of much larger size than a disk sector. However, due to the prevalence of hosts running disk operating systems, flash memory devices, particularly removably memory cards have traditionally also been adopting the logical address interface in order to be compatible.

### SUMMARY OF THE INVENTION

It is a general object of the invention to provide high performance and efficient flash memory devices.

For efficient operation, the memory system described herein directly stores data in the form of individual files. Each data file is stored with a unique identification, such as simply a number, and its data is represented by offset addresses within the file.

### Memory Allocation for File Data in a Direct File Storage System

According to one aspect of the invention, in a memory system with a file storage system, a scheme for allocating memory locations for a write operation is to write the files one after another in a memory block rather than to start a new file in a new block. When operated over a majority of blocks to be written, this scheme is particularly efficient for files that have a size smaller than that of a block. In this way, they are more efficiently packed into the blocks by being written closely following one after another, even if they belong to different data files.

In a preferred embodiment, the individual blocks are organized into multiple pages; and file data from each write operation are written to within less than one page following file data written in the last write operation. This is applicable when the data is aligned to a page.

In another preferred embodiment, an incrementing write pointer points to the write location in memory for the next data for a file, which is independent of the offset address of the data within the file. When a current write block becomes filled with file data, an erased block is allocated, and the write pointer is moved to this block.

The write pointer defines the location for the next file data to be written in all cases, including when original data is to be appended to the file, when original data is to be inserted within the existing file, and when existing data is to be updated within the file.

In another embodiment, multiple write pointers allow multiple files to be concurrently updated. Ideally, there should be at least one write pointer per file that has been opened for updating, but the number of write pointers, or number of write blocks should be limited to some predetermined number. If the number of opened files exceeds a limit, then the next opened file should be written at a write pointer after one of the currently open files.

In yet another embodiment, an incrementing relocation pointer points to the write location in memory for the next data for a file to be relocated during a garbage collection or data compaction operation. The garbage collection or data compaction are typically triggered by existence of obsolete data in a block after a file delete or file update operation. The invention also prescribes that garbage collection is to be triggered if the number of file fragments or residual data portions exceeds a predetermined number, e.g., two. The number of file fragments is the number of blocks storing this file's data with some other file's data. In this way, when a file is deleted, only a limited number of blocks also containing other file's data will need to be garbage collected.

Thus, the file data from different data files can be efficiently packed among the blocks, while the extent of mixing of the file data with that of another among the blocks is controlled so that garbage collection does not have to process an excessive number of blocks and which in turn defines the worst case garbage collection will have to contend with.

### Page-Alignment in a Direct File Storage System

According to one aspect of the present invention, each portion belonging to a data file is identified by its file ID and an offset along the data file, where the offset is a constant for the file and every file data portion is always kept at the same position within a memory page to be read or programmed in parallel. In this way, every time a page containing a file portion is read and copy to another page, the data in it is always page-aligned, and each bit within the file portion can always be manipulated by the same sense amplifier and same set data latches within the same memory column.

In a preferred implementation, the page alignment is such that (offset within a page)=(data offset within a file) MOD (page size).

In a preferred embodiment, when a page is written with page-aligned file data portion, gaps may exist before or after the file data portion. These gaps can be padded with any existing page-aligned valid data. This is equivalent to rounding up the physical file size.

Thus, in the case of data update or garbage collection every data portion remains at the same position with the physical page. When the data portions are page-aligned, data relocation time is minimized due to reducing the number of page reads during garbage collection.

It allows using the On-Chip copy feature, pipelining data copy in multi-chip configuration, and reduces the worst case garbage collection latency by limiting data fragmentation in memory. When the data is page-aligned, a logical page of data will be copied to a physical page as compared to non-aligned data where a logical page may be distributed over two physical pages. Thus, page-alignment also helps to avoid read or programming two physical pages to manipulate one page of logical data.

### Adaptive File Data Handling in a Direct File Storage System

According to another aspect of the invention, in a memory system with a file storage system, an optimal file handling scheme is adaptively selected from a group thereof based on the attributes of the file being handled. The file attributes may be obtained from a host or derived from a history of the file had with the memory system.

In a preferred embodiment, a scheme for allocating memory locations for a write operation is dependent on an estimated size of the file to be written. If the files have a size smaller than that of a block, they are more efficiently packed into the blocks by being written contiguously one after another. If the files have a size larger than that of a block, each file is preferably written to a new block.

In another preferred embodiment, a scheme for allocating memory locations for a relocation operation, such as for garbage collection or data compaction, is dependent on an estimated access frequency of the file in question. If the file data belonging to a file that is frequently accessed, they are relocated to a block that collect file data with similar file attributes. Likewise, if the file data belonging to a file that is relatively infrequently accessed, they are relocated to a block to collect file data with similar file attributes.

Other aspects, advantages, features and details of the present invention are included in a description of exemplary examples thereof that follows, which description should be taken in conjunction with the accompanying drawings. Further, all patents, patent applications, articles and other publications, documents and things referenced herein are hereby incorporated herein by this reference in their entirety for all purposes.

### BRIEF DESCRIPTION OF THE DRAWINGS

FIG. 1 schematically illustrates a host and a connected non-volatile memory system as currently implemented;

FIG. 2 is a block diagram of an example flash memory system for use as the non-volatile memory of FIG. 1;

FIG. 3 is a representative circuit diagram of a memory cell array that may be used in the system of FIG. 2;

FIG. 4 illustrates an example physical memory organization of the system of FIG. 2;

FIG. 5 shows an expanded view of a portion of the physical memory of FIG. 4;

FIG. 6 shows a further expanded view of a portion of the physical memory of FIGS. 4 and 5;

FIG. 7 illustrates a logical address space interface between a host and a re-programmable memory system;

FIG. 8 illustrates in a different manner than FIG. 7 a logical address space interface between a host and a re-programmable memory system;

FIG. 9 illustrates a direct data file storage interface between a host and a re-programmable memory system;

FIG. 10 illustrates, in a different manner than FIG. 9, a direct data file storage interface between a host and a re-programmable memory system;

FIG. 11 illustrates a host write of a file to the memory system;

FIGS. 12A-12E illustrate examples of file operating commands in the direct file storage system;

FIG. 13A illustrates three files A, B and C that are each less than the size of a metablock such as BL0, BL1 and BL2.

FIG. 13B illustrate the manner the three files of FIG. 13A are written to memory.

FIG. 14 is a flow diagram illustrating a write operation for direct file system, according to the present invention.

FIG. 15A illustrates the state of the write pointer just prior to writing file A.

FIG. 15B illustrates the state of the write pointer after writing file A.

FIG. 15C illustrates the state of the write pointer after writing file B.

FIG. 15D illustrates the state of the write pointer after writing file C.

FIG. 16A illustrates the three, to be written example files A, B and C as shown in FIG. 15A.

FIG. 16B illustrates the state of the memory blocks after successive writes of the three files, similar to that shown in FIG. 15D.

FIG. 16C illustrates the state of the memory blocks after a deletion of file A.

FIG. 16D illustrates the state of the memory blocks after a relocation of the valid data in the obsolete block.

FIG. 17A illustrates the three, to be written example files A, B and C as shown in FIG. 15A.

FIG. 17B illustrates the state of the memory blocks after successive writes of the three files, similar to that shown in FIG. 15D.

FIG. 17C illustrates the state of the memory blocks after a deletion of file B.

FIG. 18A illustrates the three, to be written example files A, B and C as shown in FIG. 15A.

FIG. 18B illustrates the state of the memory blocks after successive writes which result in the file B being split into portions B1, B2 and B3, respectively scattered over the three blocks BL0, BL1 and BL2.

FIG. 18C illustrates the state of the memory blocks after a relocation of all valid data in the blocks containing file B.

FIG. 19 is a state diagram showing the block transitions from one state to another.

FIG. 20 illustrates a page-non-aligned relocation of a data file from one block to another according to a conventional method.

FIG. 21 illustrates a page-aligned relocation of a data file from one block to another according to a preferred embodiment of the present invention.

FIG. 22 illustrates a page-non-aligned compaction of a data file from one block to another according to a conventional method.

FIG. 23 illustrates a page-aligned compaction of a data file from one block to another according to a preferred embodiment of the present invention.

FIG. 24A is a flow diagram illustrating storing file data in memory with page-alignment, according the present invention.

FIG. 24B is prescription for page alignment of a data file, according a preferred embodiment of the present invention.

FIG. 25 is a flow diagram illustrating the adaptive file data handling scheme depending on file attributes, according the present invention.

FIG. 26A illustrates the allocation scheme for writing three example files, according to the “small file size handling scheme”.

FIG. 26B illustrates another allocation scheme for writing the same three example files shown in FIG. 26A, according to the “large file size handling scheme”.

FIG. 26C illustrate an adaptive allocation scheme for optimally writing files of all sizes, according to a preferred embodiment.

FIG. 27 is a flow diagram illustrating the adaptive file data handling scheme depending on file size as an example file attribute, according to a preferred embodiment of the present invention.

FIG. 28A illustrates the adaptive file data handling scheme for write block selection depending on a file attribute indicating estimated file update frequency, according to a preferred embodiment of the present invention.

FIG. 28B is a flow diagram illustrating the adaptive file data handling scheme depending on a file attribute indicating estimated file update frequency, according to a preferred embodiment of the present invention.

FIG. 29A illustrates the adaptive file data handling scheme for relocation block selection depending on a file attribute indicating estimated file update frequency, according to a preferred embodiment of the present invention.

FIG. 29B is a flow diagram illustrating the adaptive file data handling scheme depending on a file attribute indicating estimated file update frequency, according to a preferred embodiment of the present invention.

FIG. 30A illustrates the adaptive file data handling scheme for relocation block and write block selection depending on a file attribute indicating estimated file update frequency, according to a preferred embodiment of the present invention.

FIG. 30B is a flow diagram illustrating the adaptive file data handling scheme depending on a file attribute indicating estimated file update frequency, according to a preferred embodiment of the present invention.

### FLASH MEMORY SYSTEM GENERAL DESCRIPTION

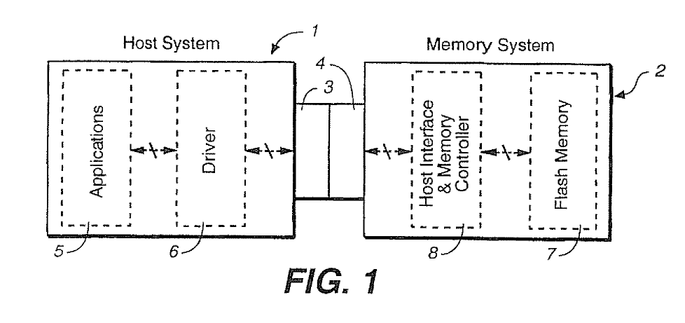

A common flash memory system is first described with respect to FIGS. 1-6. It is in such a system that the various aspects of the present invention may be implemented. A host system 1 of FIG. 1 stores data into and retrieves data from a flash memory 2. Although the flash memory can be embedded within the host, the memory 2 is illustrated to be in the more popular form of a card that is removably connected to the host through mating parts 3 and 4 of a mechanical and electrical connector. There are currently many different flash memory cards that are commercially available, examples being the CompactFlash (CF), the MultiMediaCard (MMC), Secure Digital (SD), miniSD, Memory Stick, SmartMedia and TransFlash cards. Although each of these cards has a unique mechanical and/or electrical interface according to its standardized specifications, the flash memory system included in each is similar. These cards are all available from SanDisk Corporation, assignee of the present application. SanDisk also provides a line of flash drives under its Cruzer trademark, which are hand held memory systems in small packages that have a Universal Serial Bus (USB) plug for connecting with a host by plugging into the host's USB receptacle. Each of these memory cards and flash drives includes controllers that interface with the host and control operation of the flash memory within them.

Host systems that use such memory cards and flash drives are many and varied. They include personal computers (PCs), laptop and other portable computers, cellular telephones, personal digital assistants (PDAs), digital still cameras, digital movie cameras and portable audio players. The host typically includes a built-in receptacle for one or more types of memory cards or flash drives but some require adapters into which a memory card is plugged. The memory system usually contains its own memory controller and drivers but there are also some memory only systems that are instead controlled by software executed by the host to which the memory is connected. In some memory systems containing the controller, especially those embedded within a host, the memory, controller and drivers are often formed on a single integrated circuit chip.

The host system 1 of FIG. 1 may be viewed as having two major parts, insofar as the memory 2 is concerned, made up of a combination of circuitry and software. They are an applications portion 5 and a driver portion 6 that interfaces with the memory 2. In a personal computer, for example, the applications portion 5 can include a processor running word processing, graphics, control or other popular application software. In a camera, cellular telephone or other host system that is primarily dedicated to performing a single set of functions, the applications portion 5 includes the software that operates the camera to take and store pictures, the cellular telephone to make and receive calls, and the like.

The memory system 2 of FIG. 1 includes flash memory 7, and circuits 8 that both interface with the host to which the card is connected for passing data back and forth and control the memory 7. The controller 8 typically converts between logical addresses of data used by the host 1 and physical addresses of the memory 7 during data programming and reading.

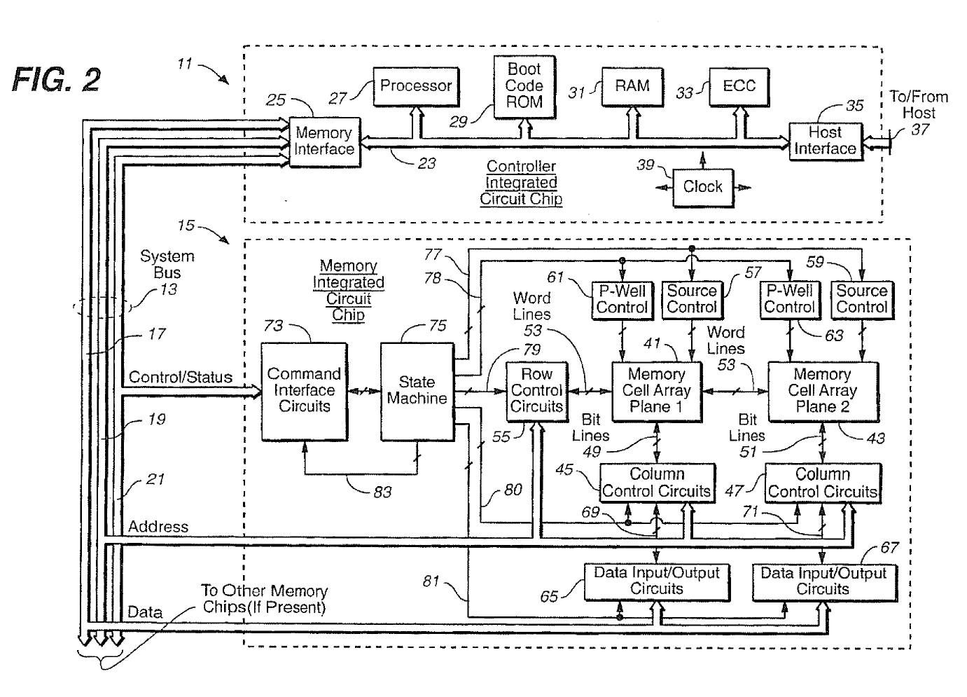

Referring to FIG. 2, circuitry of a typical flash memory system that may be used as the non-volatile memory 2 of FIG. 1 is described. The system controller is usually implemented on a single integrated circuit chip 11 that is connected in parallel with one or more integrated circuit memory chips over a system bus 13, a single such memory chip 15 being shown in FIG. 2. The particular bus 13 that is illustrated includes a separate set of conductors 17 to carry data, a set 19 for memory addresses and a set 21 for control and status signals. Alternatively, a single set of conductors may be time shared between these three functions. Further, other configurations of system buses can be employed, such as a ring bus that is described in U.S. patent application Ser. No. 10/915,039, filed Aug. 9, 2004,entitled “Ring Bus Structure and It's Use in Flash Memory Systems.”

A typical controller chip 11 has its own internal bus 23 that interfaces with the system bus 13 through interface circuits 25. The primary functions normally connected to the bus are a processor 27 (such as a microprocessor or micro-controller), a read-only-memory (ROM) 29 containing code to initialize (“boot”) the system, read-only-memory (RAM) 31 used primarily to buffer data being transferred between the memory and a host, and circuits 33 that calculate and check an error correction code (ECC) for data passing through the controller between the memory and the host. The controller bus 23 interfaces with a host system through circuits 35, which, in the case of the system of FIG. 2 being contained within a memory card, is done through external contacts 37 of the card that are part of the connector 4. A clock 39 is connected with and utilized by each of the other components of the controller 11.

The memory chip 15, as well as any other connected with the system bus 13, typically contains an array of memory cells organized into multiple sub-arrays or planes, two such planes 41 and 43 being illustrated for simplicity but more, such as four or eight such planes, may instead be used. Alternatively, the memory cell array of the chip 15 may not be divided into planes. When so divided however, each plane has its own column control circuits 45 and 47 that are operable independently of each other. The circuits 45 and 47 receive addresses of their respective memory cell array from the address portion 19 of the system bus 13, and decode them to address a specific one or more of respective bit lines 49 and 51. The word lines 53 are addressed through row control circuits 55 in response to addresses received on the address bus 19. Source voltage control circuits 57 and 59 are also connected with the respective planes, as are p-well voltage control circuits 61 and 63. If the memory chip 15 has a single array of memory cells, and if two or more such chips exist in the system, the array of each chip may be operated similarly to a plane or sub-array within the multi-plane chip described above.

Data are transferred into and out of the planes 41 and 43 through respective data input/output circuits 65 and 67 that are connected with the data portion 17 of the system bus 13. The circuits 65 and 67 provide for both programming data into the memory cells and for reading data from the memory cells of their respective planes, through lines 69 and 71 connected to the planes through respective column control circuits 45 and 47.

Although the controller 11 controls the operation of the memory chip 15 to program data, read data, erase and attend to various housekeeping matters, each memory chip also contains some controlling circuitry that executes commands from the controller 11 to perform such functions. Interface circuits 73 are connected to the control and status portion 21 of the system bus 13. Commands from the controller are provided to a state machine 75 that then provides specific control of other circuits in order to execute these commands. Control lines 77-81 connect the state machine 75 with these other circuits as shown in FIG. 2. Status information from the state machine 75 is communicated over lines 83 to the interface 73 for transmission to the controller 11 over the bus portion 21.

A NAND architecture of the memory cell arrays 41 and 43 is currently preferred, although other architectures, such as NOR, can also be used instead. Examples of NAND flash memories and their operation as part of a memory system may be had by reference to U.S. Pat. Nos. 5,570,315, 5,774,397, 6,046,935, 6,373,746, 6,456,528, 6,522,580, 6,771,536 and 6,781,877 and U.S. patent application publication no. 2003/0147278.

Other memory devices such as those utilizing dielectric storage element are also applicable. For example, U.S. Pat. Nos. 5,768,192 and 6,011,725 disclose a nonvolatile memory cell having a trapping dielectric sandwiched between two silicon dioxide layers. Multi-state data storage is implemented by separately reading the binary states of the spatially separated charge storage regions within the dielectric.

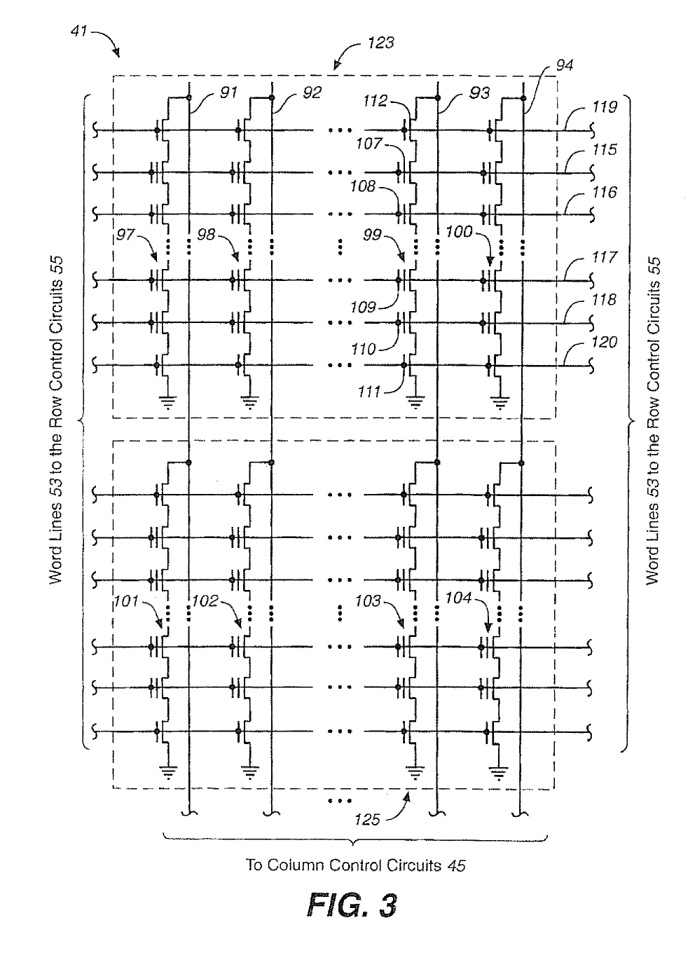

An example NAND array is illustrated by the circuit diagram of FIG. 3, which is a portion of the memory cell array 41 of the memory system of FIG. 2. A large number of global bit lines are provided, only four such lines 91-94 being shown in FIG. 2 for simplicity of explanation. A number of series connected memory cell strings 97-104 are connected between one of these bit lines and a reference potential. Using the memory cell string 99 as representative, a plurality of charge storage memory cells 107-110 are connected in series with select transistors 111 and 112 at either end of the string. When the select transistors of a string are rendered conductive, the string is connected between its bit line and the reference potential. One memory cell within that string is then programmed or read at a time.

Word lines 115-118 of FIG. 3 individually extend across the charge storage element of one memory cell in each of a number of strings of memory cells, and gates 119 and 120 control the states of the select transistors at each end of the strings. The memory cell strings that share common word and control gate lines 115-120 are made to form a block 123 of memory cells that are erased together. This block of cells contains the minimum number of cells that are physically erasable at one time. One row of memory cells, those along one of the word lines 115-118, are programmed at a time. Typically, the rows of a NAND array are programmed in a prescribed order, in this case beginning with the row along the word line 118 closest to the end of the strings connected to ground or another common potential. The row of memory cells along the word line 117 is programmed next, and so on, throughout the block 123. The row along the word line 115 is programmed last.

A second block 125 is similar, its strings of memory cells being connected to the same global bit lines as the strings in the first block 123 but having a different set of word and control gate lines. The word and control gate lines are driven to their proper operating voltages by the row control circuits 55. If there is more than one plane or sub-array in the system, such as planes 1 and 2 of FIG. 2, one memory architecture uses common word lines extending between them. There can alternatively be more than two planes or sub-arrays that share common word lines. In other memory architectures, the word lines of individual planes or sub-arrays are separately driven.

As described in several of the NAND patents and published application referenced above, the memory system may be operated to store more than two detectable levels of charge in each charge storage element or region, thereby to store more than one bit of data in each. The charge storage elements of the memory cells are most commonly conductive floating gates but may alternatively be non-conductive dielectric charge trapping material, as described in U.S. patent application publication no. 2003/0109093.

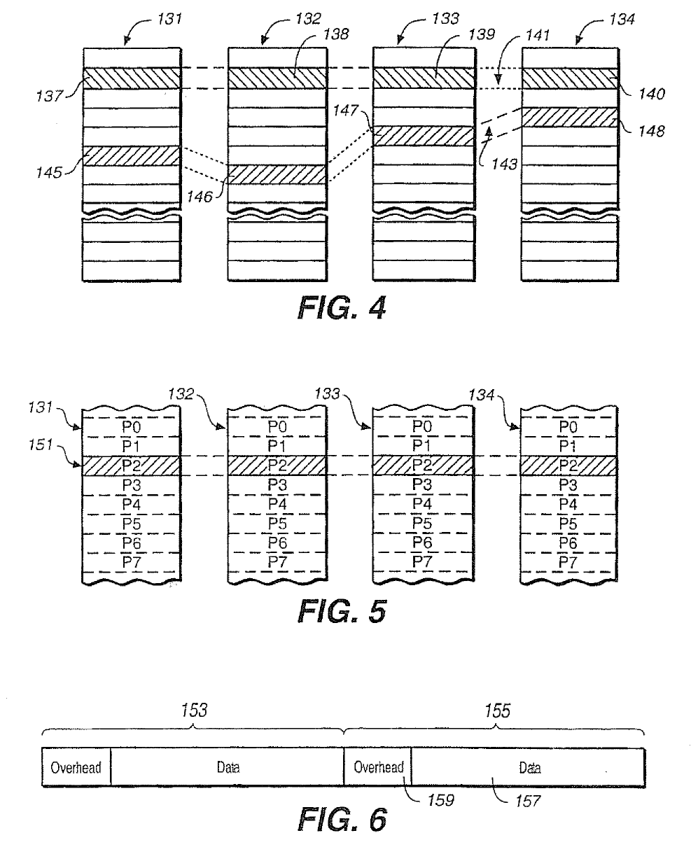

FIG. 4 conceptually illustrates an organization of the flash memory cell array 7 (FIG. 1) that is used as an example in further descriptions below. Four planes or sub-arrays 131-134 of memory cells may be on a single integrated memory cell chip, on two chips (two of the planes on each chip) or on four separate chips. The specific arrangement is not important to the discussion below. Of course, other numbers of planes, such as 1, 2, 8, 16 or more may exist in a system. The planes are individually divided into blocks of memory cells shown in FIG. 4 by rectangles, such as blocks 137, 138, 139 and 140, located in respective planes 131-134. There can be dozens or hundreds of blocks in each plane. As mentioned above, the block of memory cells is the unit of erase, the smallest number of memory cells that are physically erasable together. For increased parallelism, however, the blocks are operated in larger metablock units. One block from each plane is logically linked together to form a metablock. The four blocks 137-140 are shown to form one metablock 141. All of the cells within a metablock are typically erased together. The blocks used to form a metablock need not be restricted to the same relative locations within their respective planes, as is shown in a second metablock 143 made up of blocks 145-148. Although it is usually preferable to extend the metablocks across all of the planes, for high system performance, the memory system can be operated with the ability to dynamically form metablocks of any or all of one, two or three blocks in different planes. This allows the size of the metablock to be more closely matched with the amount of data available for storage in one programming operation.

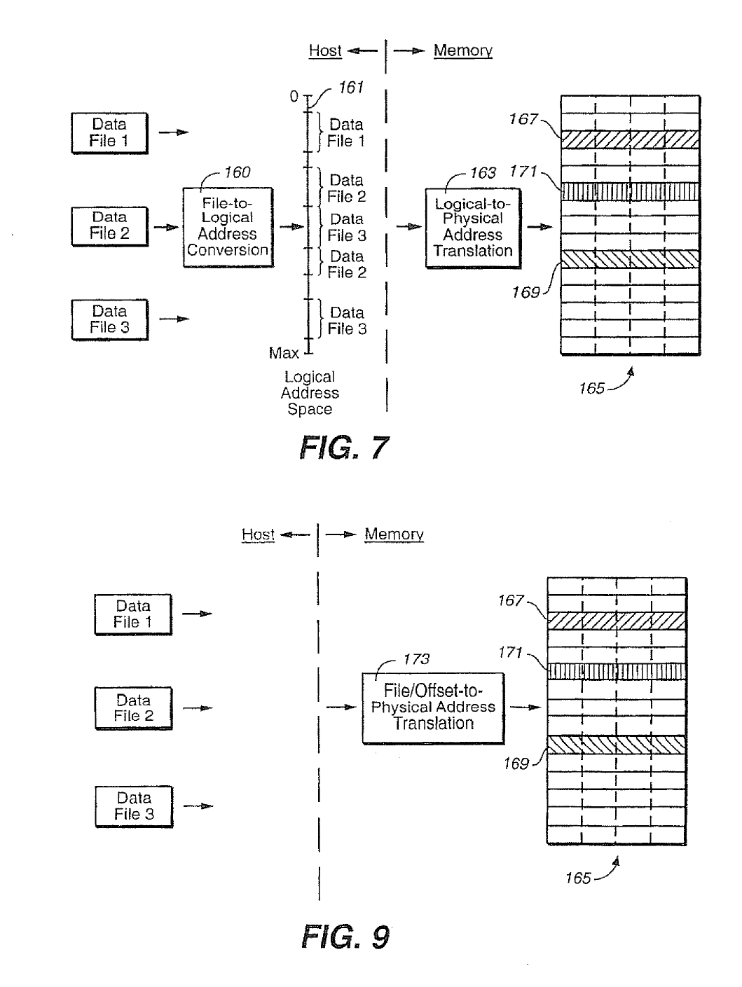

The individual blocks are in turn divided for operational purposes into pages of memory cells, as illustrated in FIG. 5. The memory cells of each of the blocks 131-134, for example, are each divided into eight pages P0-P7. Alternatively, there may be 16, 32 or more pages of memory cells within each block. The page is the unit of data programming and reading within a block, containing the minimum amount of data that are programmed or read at one time. In the NAND architecture of FIG. 3, a page is formed of memory cells along a word line within a block. However, in order to increase the memory system operational parallelism, such pages within two or more blocks may be logically linked into metapages. A metapage 151 is illustrated in FIG. 5, being formed of one physical page from each of the four blocks 131-134. The metapage 151, for example, includes the page P2 in of each of the four blocks but the pages of a metapage need not necessarily have the same relative position within each of the blocks. A metapage is the maximum unit of programming.

Although it is preferable to program and read the maximum amount of data in parallel across all four planes, for high system performance, the memory system can also be operated to form metapages of any or all of one, two or three pages in separate blocks in different planes. This allows the programming and reading operations to adaptively match the amount of data that may be conveniently handled in parallel and reduces the occasions when part of a metapage remains unprogrammed with data.

A metapage formed of physical pages of multiple planes, as illustrated in FIG. 5, contains memory cells along word line rows of those multiple planes. Rather than programming all of the cells in one word line row at the same time, they are more commonly alternately programmed in two or more interleaved groups, each group storing a page of data (in a single block) or a metapage of data (across multiple blocks). By programming alternate memory cells at one time, a unit of peripheral circuits including data registers and a sense amplifier need not be provided for each bit line but rather are time-shared between adjacent bit lines. This economizes on the amount of substrate space required for the peripheral circuits and allows the memory cells to be packed with an increased density along the rows. Otherwise, it is preferable to simultaneously program every cell along a row in order to maximize the parallelism available from a given memory system.

With reference to FIG. 3, the simultaneous programming of data into every other memory cell along a row is most conveniently accomplished by providing two rows of select transistors (not shown) along at least one end of the NAND strings, instead of the single row that is shown. The select transistors of one row then connect every other string within a block to their respective bit lines in response to one control signal, and the select transistors of the other row connect intervening every other string to their respective bit lines in response to another control signal. Two pages of data are therefore written into each row of memory cells.

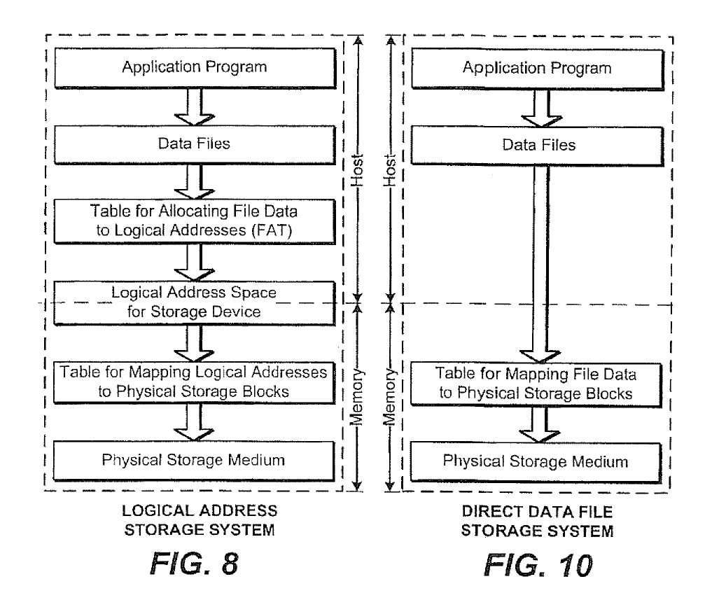

The amount of data in each logical page is typically an integer number of one or more sectors of data, each sector containing 512 bytes of data, by convention. The sector is the minimum unit of data transferred to and from the memory system. FIG. 6 shows a logical data page of two sectors 153 and 155 of data of a page or metapage. Each sector usually contains a portion 157 of 512 bytes of user or system data being stored and another number of bytes 159 for overhead data related either to the data in the portion 157 or to the physical page or block in which it is stored. The number of bytes of overhead data is typically 16 bytes, making the total 528 bytes for each of the sectors 153 and 155. The overhead portion 159 may contain an ECC calculated from the data portion 157 during programming, its logical address, an experience count of the number of times the block has been erased and re-programmed, one or more control flags, operating voltage levels, and/or the like, plus an ECC calculated from such overhead data 159. Alternatively, the overhead data 159, or a portion of it, may be stored in different pages in other blocks. In either case, a sector denotes a unit of stored data with which an ECC is associated.

As the parallelism of memories increases, data storage capacity of the metablock increases and the size of the data page and metapage also increase as a result. The data page may then contain more than two sectors of data. With two sectors in a data page, and two data pages per metapage, there are four sectors in a metapage. Each metapage thus stores 2048 bytes of data. This is a high degree of parallelism, and can be increased even further as the number of memory cells in the rows are increased. For this reason, the width of flash memories is being extended in order to increase the amount of data in a page and a metapage.

### Host-Memory Interface and General Memory Operation

The physically small re-programmable non-volatile memory cards and flash drives identified above are commercially available with data storage capacity of 512 megabytes (MB), 1 gigabyte (GB), 2 GB and 4 GB, and may go higher. The host deals with data files generated or used by application software or firmware programs executed by the host. A word processing data file is an example, and a drawing file of computer aided design (CAD) software is another, found mainly in general computer hosts such as PCs, laptop computers and the like. A document in the pdf format is also such a file. A still digital video camera generates a data file for each picture that is stored on a memory card. A cellular telephone utilizes data from files on an internal memory card, such as a telephone directory. A PDA stores and uses several different files, such as an address file, a calendar file, and the like. In any such application, the memory card may also contain software that operates the host.

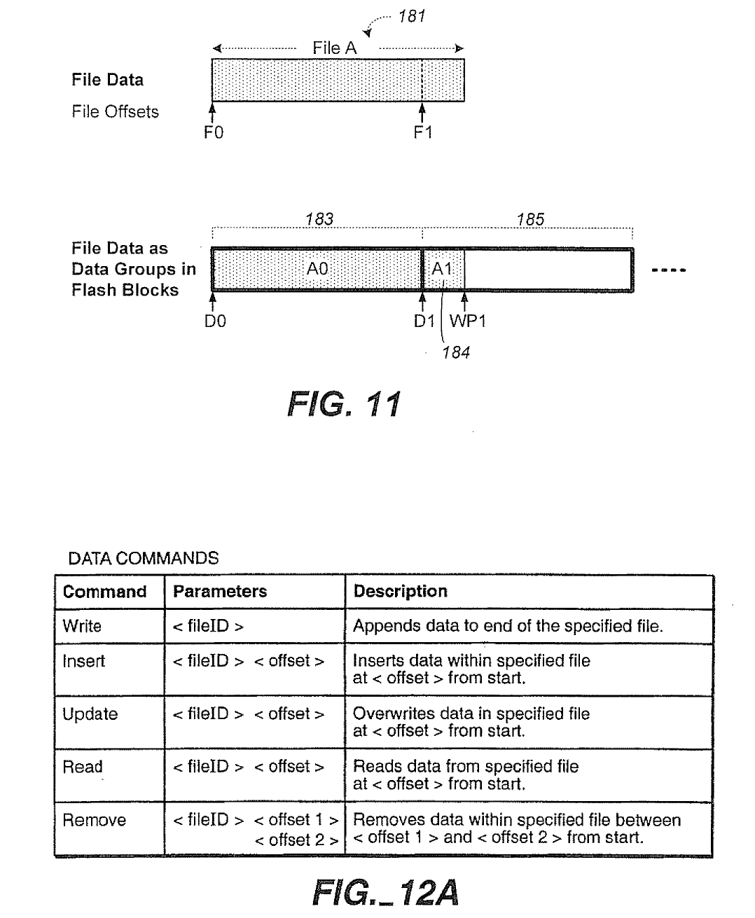

A common logical interface between the host and the memory system is illustrated in FIG. 7. A continuous logical address space 161 is large enough to provide addresses for all the data that may be stored in the memory system. The host address space is typically divided into increments of clusters of data. Each cluster may be designed in a given host system to contain a number of sectors of data, somewhere between 4 and 64 sectors being typical. A standard sector contains 512 bytes of data.

Three Data Files 1, 2 and 3 are shown in the example of FIG. 7 to have been created. An application program running on the host system creates each file as an ordered set of data and identifies it by a unique name or other reference. Enough available logical address space not already allocated to other files is assigned by the host to Data File 1, by a file-to-logical address conversion 160. Data File 1 is shown to have been assigned a contiguous range of available logical addresses. Ranges of addresses are also commonly allocated for specific purposes, such as a particular range for the host operating software, which are then avoided for storing data even if these addresses have not been utilized at the time the host is assigning logical addresses to the data.

When a Data File 2 is later created by the host, the host similarly assigns two different ranges of contiguous addresses within the logical address space 161, by the file-to-logical address conversion 160 of FIG. 7. A file need not be assigned contiguous logical addresses but rather can be fragments of addresses in between address ranges already allocated to other files. This example then shows that yet another Data File 3 created by the host is allocated other portions of the host address space not previously allocated to the Data Files 1 and 2 and other data.

The host keeps track of the memory logical address space by maintaining a file allocation table (FAT), where the logical addresses assigned by the host to the various host files by the conversion 160 are maintained. The FAT table is frequently updated by the host as new files are stored, other files deleted, files modified and the like. The FAT table is typically stored in a host memory, with a copy also stored in the non-volatile memory that is updated from time to time. The copy is typically accessed in the non-volatile memory through the logical address space just like any other data file. When a host file is deleted, the host then deallocates the logical addresses previously allocated to the deleted file by updating the FAT table to show that they are now available for use with other data files.

The host is not concerned about the physical locations where the memory system controller chooses to store the files. The typical host only knows its logical address space and the logical addresses that it has allocated to its various files. The memory system, on the other hand, through the typical host/card interface being described, only knows the portions of the logical address space to which data have been written but does not know the logical addresses allocated to specific host files, or even the number of host files. The memory system controller converts the logical addresses provided by the host for the storage or retrieval of data into unique physical addresses within the flash memory cell array where host data are stored. A block 163 represents a working table of these logical-to-physical address conversions, which is maintained by the memory system controller.

The memory system controller is programmed to store data within the blocks and metablocks of a memory array 165 in a manner to maintain the performance of the system at a high level. Four planes or sub-arrays are used in this illustration. Data are preferably programmed and read with the maximum degree of parallelism that the system allows, across an entire metablock formed of a block from each of the planes. At least one metablock 167 is usually allocated as a reserved block for storing operating firmware and data used by the memory controller. Another metablock 169, or multiple metablocks, may be allocated for storage of host operating software, the host FAT table and the like. Most of the physical storage space remains for the storage of data files. The memory controller does not know, however, how the data received has been allocated by the host among its various file objects. All the memory controller typically knows from interacting with the host is that data written by the host to specific logical addresses are stored in corresponding physical addresses as maintained by the controller's logical-to-physical address table 163.

In a typical memory system, a few extra blocks of storage capacity are provided than are necessary to store the amount of data within the address space 161. One or more of these extra blocks may be provided as redundant blocks for substitution for other blocks that may become defective during the lifetime of the memory. The logical grouping of blocks contained within individual metablocks may usually be changed for various reasons, including the substitution of a redundant block for a defective block originally assigned to the metablock. One or more additional blocks, such as metablock 171, are typically maintained in an erased block pool. Most of the remaining metablocks shown in FIG. 7 are used to store host data. When the host writes data to the memory system, the function 163 of the controller converts the logical addresses assigned by the host to physical addresses within a metablock in the erased block pool. Other metablocks not being used to store data within the logical address space 161 are then erased and designated as erased pool blocks for use during a subsequent data write operation. In a preferred form, the logical address space is divided into logical groups that each contain an amount of data equal to the storage capacity of a physical memory metablock, thus allowing a one-to-one mapping of the logical groups into the metablocks.

Data stored at specific host logical addresses are frequently overwritten by new data as the original stored data become obsolete. The memory system controller, in response, writes the new data in an erased block and then changes the logical-to-physical address table for those logical addresses to identify the new physical block to which the data at those logical addresses are stored. The blocks containing the original data at those logical addresses are then erased and made available for the storage of new data. Such erasure often must take place before a current data write operation may be completed if there is not enough storage capacity in the pre-erased blocks from the erase block pool at the start of writing. This can adversely impact the system data programming speed. The memory controller typically learns that data at a given logical address has been rendered obsolete by the host only when the host writes new data to their same logical address. Many blocks of the memory can therefore be storing such invalid data for a time.

The sizes of blocks and metablocks are increasing in order to efficiently use the area of the integrated circuit memory chip. This results in a large proportion of individual data writes storing an amount of data that is less than the storage capacity of a metablock, and in many cases even less than that of a block. Since the memory system controller normally directs new data to an erased pool metablock, this can result in portions of metablocks going unfilled. If the new data are updates of some data stored in another metablock, remaining valid metapages of data from that other metablock having logical addresses contiguous with those of the new data metapages are also desirably copied in logical address order into the new metablock. The old metablock may retain other valid data metapages. This results over time in data of certain metapages of an individual metablock being rendered obsolete and invalid, and replaced by new data with the same logical address being written to a different metablock.

In order to maintain enough physical memory space to store data over the entire logical address space 161, such data are periodically compacted or consolidated (garbage collection). It is also desirable to maintain sectors of data within the metablocks in the same order as their logical addresses as much as practical, since this makes reading data in contiguous logical addresses more efficient. So data compaction and garbage collection are typically performed with this additional goal. Some aspects of managing a memory when receiving partial block data updates and the use of metablocks are described in U.S. Pat. No. 6,763,424.

Data compaction typically involves reading all valid data metapages from a metablock and writing them to a new block, ignoring metapages with invalid data in the process. The metapages with valid data are also preferably arranged with a physical address order that matches the logical address order of the data stored in them. The number of metapages occupied in the new metablock will be less than those occupied in the old metablock since the metapages containing invalid data are not copied to the new metablock. The old block is then erased and made available to store new data. The additional metapages of capacity gained by the consolidation can then be used to store other data.

During garbage collection, metapages of valid data with contiguous or near contiguous logical addresses are gathered from two or more metablocks and re-written into another metablock, usually one in the erased block pool. When all valid data metapages are copied from the original two or more metablocks, they may be erased for future use.

Data consolidation and garbage collection take time and can affect the performance of the memory system, particularly if data consolidation or garbage collection needs to take place before a command from the host can be executed. Such operations are normally scheduled by the memory system controller to take place in the background as much as possible but the need to perform these operations can cause the controller to have to give the host a busy status signal until such an operation is completed. An example of where execution of a host command can be delayed is where there are not enough pre-erased metablocks in the erased block pool to store all the data that the host wants to write into the memory, so data consolidation or garbage collection is needed first to clear one or more metablocks of valid data, which can then be erased. Attention has therefore been directed to managing control of the memory in order to minimize such disruptions. Many such techniques are described in the following United States patent applications, referenced hereinafter as the “LBA Patent Applications”: Ser. No. 10/749,831, filed Dec. 30, 2003, entitled “Management of Non-Volatile Memory Systems Having Large Erase Blocks”; Ser. No. 10/750,155, filed Dec. 30, 2003, entitled “Non-Volatile Memory and Method with Block Management System”; Ser. No. 10/917,888, filed Aug. 13, 2004, entitled “Non-Volatile Memory and Method with Memory Planes Alignment”; Ser. No. 10/917,867, filed Aug. 13, 2004; Ser. No. 10/917,889, filed Aug. 13, 2004, entitled “Non-Volatile Memory and Method with Phased Program Failure Handling”; and Ser. No. 10/917,725, filed Aug. 13, 2004, entitled “Non-Volatile Memory and Method with Control Data Management”; Ser. No. 11/192,220, filed Jul. 27, 2005, entitled “Non-Volatile Memory and Method with Multi-Stream Update Tracking”; Ser. No. 11/192,386, filed Jul. 27, 2005, entitled “Non-Volatile Memory and Method with Improved Indexing for Scratch Pad and Update Blocks”; and Ser. No. 11/191,686, filed Jul. 27, 2005, entitled “Non-Volatile Memory and Method with Multi-Stream Updating”.

One challenge to efficiently control operation of memory arrays with very large erase blocks is to match and align the number of data sectors being stored during a given write operation with the capacity and boundaries of blocks of memory. One approach is to configure a metablock used to store new data from the host with less than a maximum number of blocks, as necessary to store a quantity of data less than an amount that fills an entire metablock. The use of adaptive metablocks is described in U.S. patent application Ser. No. 10/749,189, filed Dec. 30, 2003, entitled “Adaptive Metablocks.” The fitting of boundaries between blocks of data and physical boundaries between metablocks is described in patent applications Ser. No. 10/841,118, filed May 7, 2004, and Ser. No. 11/016,271, filed Dec. 16, 2004, entitled “Data Run Programming.”

The memory controller may also use data from the FAT table, which is stored by the host in the non-volatile memory, to more efficiently operate the memory system. One such use is to learn when data has been identified by the host to be obsolete by deallocating their logical addresses. Knowing this allows the memory controller to schedule erasure of the blocks containing such invalid data before it would normally learn of it by the host writing new data to those logical addresses. This is described in U.S. patent application Ser. No. 10/897,049, filed Jul. 21, 2004, entitled “Method and Apparatus for Maintaining Data on Non-Volatile Memory Systems.” Other techniques include monitoring host patterns of writing new data to the memory in order to deduce whether a given write operation is a single file, or, if multiple files, where the boundaries between the files lie. U.S. patent application Ser. No. 11/022,369, filed Dec. 23, 2004, entitled “FAT Analysis for Optimized Sequential Cluster Management,” describes the use of techniques of this type.

To operate the memory system efficiently, it is desirable for the controller to know as much about the logical addresses assigned by the host to data of its individual files as it can. Data files can then be stored by the controller within a single metablock or group of metablocks, rather than being scattered among a larger number of metablocks when file boundaries are not known. The result is that the number and complexity of data consolidation and garbage collection operations are reduced. The performance of the memory system improves as a result. But it is difficult for the memory controller to know much about the host data file structure when the host/memory interface includes the logical address space 161 (FIG. 7), as described above.

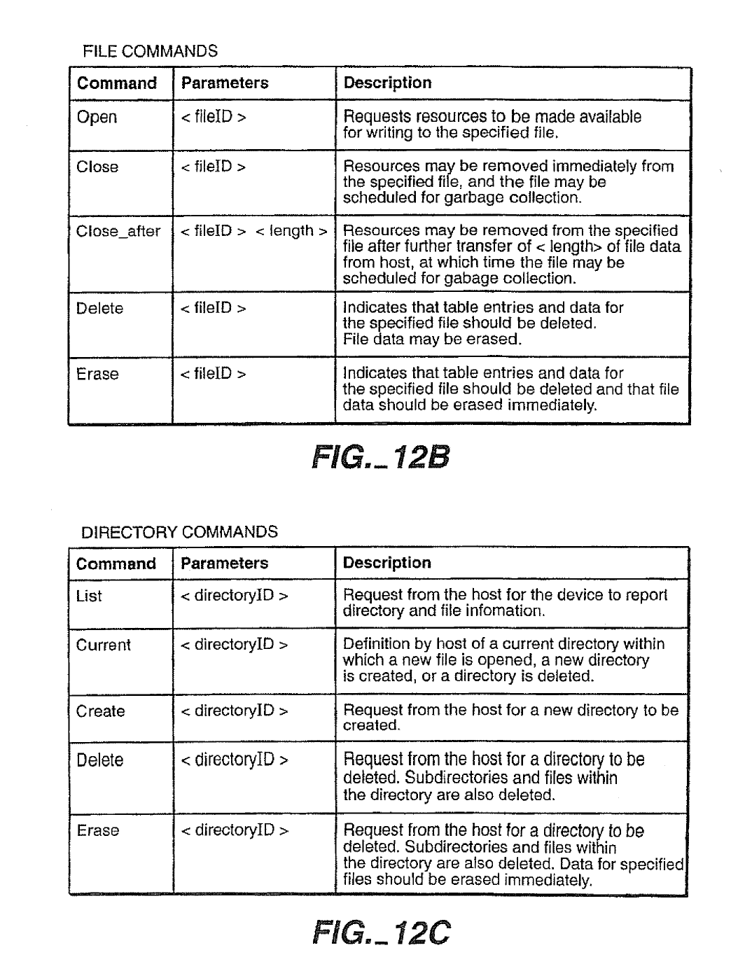

Referring to FIG. 8, the typical logical address host/memory interface as already shown in FIG. 7 is illustrated differently. The host generated data files are allocated logical addresses by the host. The memory system then sees these logical addresses and maps them into physical addresses of blocks of memory cells where the data are actually stored.

### Direct Data File Storage System

A different type of interface between the host and memory system, termed a direct data file interface, does not use the logical address space. The host instead logically addresses each file by a unique number, or other identifying reference, and offset addresses of units of data (such as bytes) within the file. This file address is given directly by the host to the memory system controller, which then keeps its own table of where the data of each host file are physically stored. This new interface can be implemented with the same memory system as described above with respect to FIGS. 2-6. The primary difference with what is described above is the manner in which that memory system communicates with a host system.

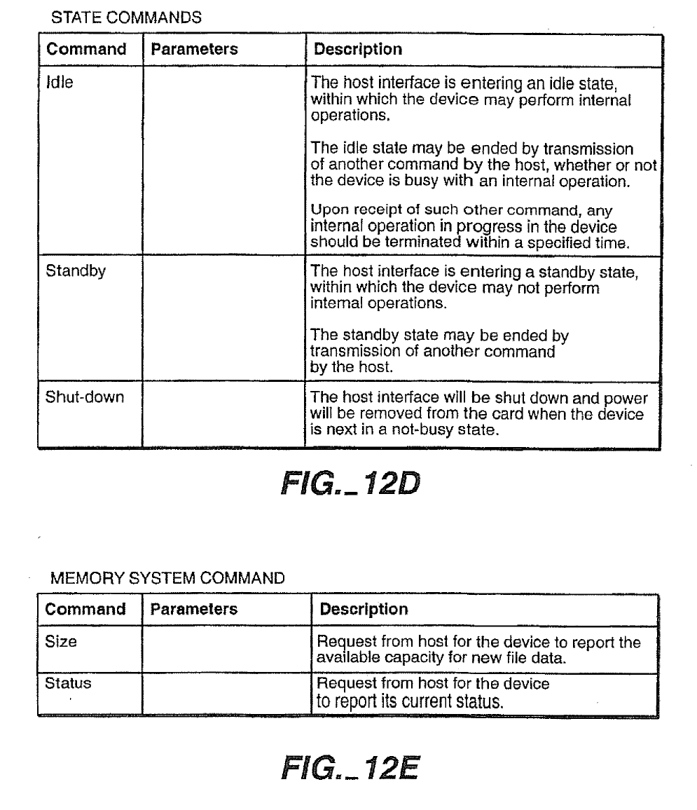

Such a direct data file interface is illustrated in FIG. 9, which may be compared with the logical address interface of FIG. 7. An identification of each of the Files 1, 2 and 3 and offsets of data within the files of FIG. 9 are passed directly to the memory controller. This logical address information is then translated by a memory controller function 173 into physical addresses of metablocks and metapages of the memory 165. A file directory keeps track of the host file to which each stored sector or other unit of data belongs.

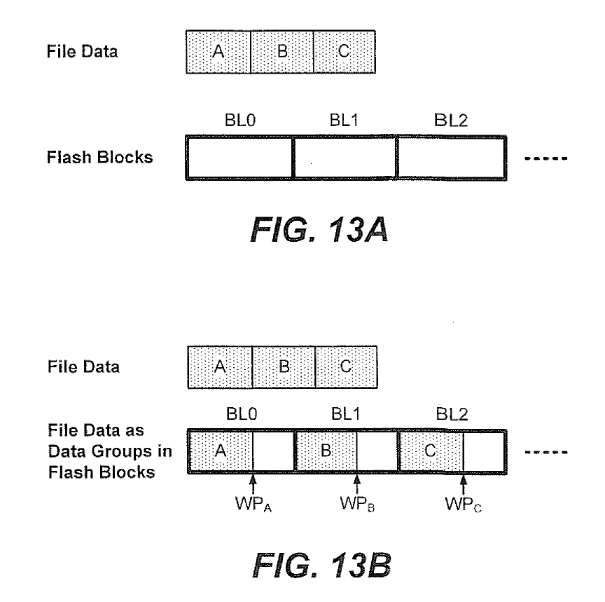

The direct data file interface is also illustrated by FIG. 10, which should be compared with the logical address interface of FIG. 8. The logical address space and host maintained FAT table of FIG. 8 are not present in FIG. 10. Rather, data files generated by the host are identified to the memory system by file number and offsets of data within the file. The memory system controller then directly maps the files to the physical blocks of the memory cell array and maintains directory and index table information of the memory blocks into which host files are stored. It is then unnecessary for the host to maintain the file allocation table (FAT) that is currently necessary for managing a logical address interface.

Since the memory system knows the locations of data making up each file, these data may be erased soon after a host deletes the file. This is not possible with a typical logical address interface. Further, by identifying host data by file objects instead of using logical addresses, the memory system controller can store the data in a manner that reduces the need for frequent data consolidation and collection. The frequency of data copy operations and the amount of data copied are thus significantly reduced, thereby increasing the data programming and reading performance of the memory system.

Since the direct data file interface of these Direct Data File Storage Applications, as illustrated by FIGS. 9 and 10, is simpler than the logical address space interface described above, as illustrated by FIGS. 7 and 8, and allows the memory system to perform better, the direct data file storage is preferred for many applications.

Direct data file storage memory systems are described in pending U.S. patent application Ser. Nos. 11/060,174, 11/060,248 and 11/060,249, all filed on Feb. 16, 2005 naming either Alan W. Sinclair alone or with Peter J. Smith, and a provisional application filed by Alan W. Sinclair and Barry Wright concurrently herewith, and entitled “Direct Data File Storage in Flash Memories”, (hereinafter collectively referenced as the “Direct Data File Storage Applications”). Also, a memory system capable of accommodating both host addressing using logical sectors and one using direct data file commands is described in pending U.S. patent application Ser. No. 11/196,869 filed Aug. 3, 2005 by Sergey A. Gorobets.

### Commands for Direct File System

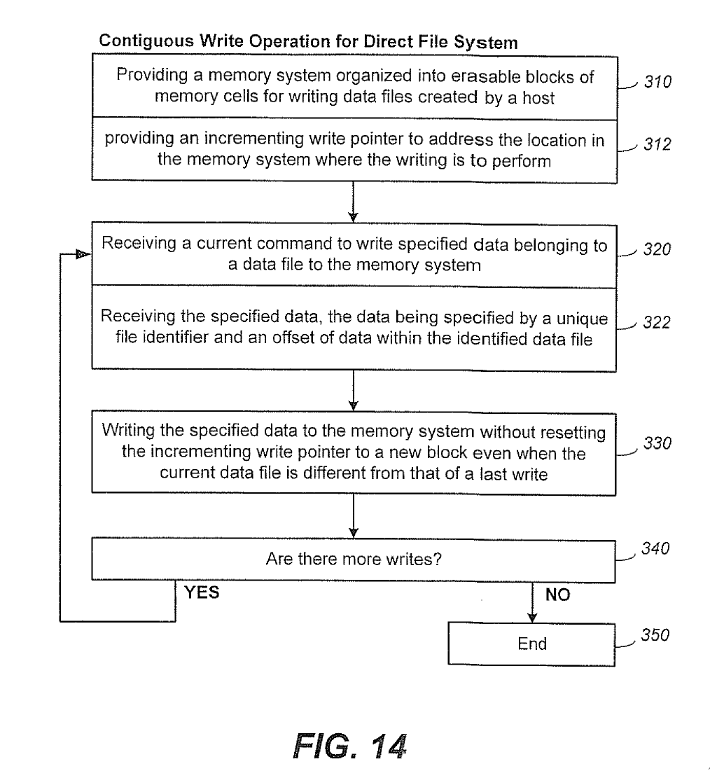

FIG. 11 illustrates a host write of a file to the memory system. When a new data file is programmed into the memory, the data are written into an erased block of memory cells beginning with the first physical location in the block and proceeding through the locations of the block sequentially in order. The data are programmed in the order received from the host, regardless of the order of the offsets of that data within the file. Programming continues until all data of the file have been written into the memory. If the amount of data in the file exceeds the capacity of a single memory block, then, when the first block is full, programming continues in a second erased block. The second memory block is programmed in the same manner as the first, in order from the first location until either all the data of the file are stored or the second block is full. A third or additional blocks may be programmed with any remaining data of the file. Multiple blocks or metablocks storing data of a single file need not be physically or logically contiguous. For ease of explanation, unless otherwise specified, it is intended that the term “block” as used herein refer to either the block unit of erase or a multiple block “metablock,” depending upon whether metablocks are being used in a specific system.

Referring to FIG. 11, a data file A 181, in this example, is larger than the storage capacity of one block or metablock 183 of the memory system, which is shown to extend between solid vertical lines. A portion 184 of the data file A1 181 is therefore also written into a second block 185. These memory cell blocks are shown to be physically contiguous but they need not be. Data from the file 181 are written as they are received streaming from the host until all the data of the file have been written into the memory. In the example, the data 181 are the initial data for file A, received from the host after a Write command.

A preferred way for the memory system to manage and keep track of the stored data is with the use of variable sized data groups. That is, data of a file are stored as a plurality of groups of data that may be chained together in a defined order to form the complete file. Preferably, however, the order of the data groups within the file is maintained by the memory system controller through use of a file index table (FIT). As a stream of data from the host are being written, a new data group is begun whenever there is a discontinuity either in the logical offset addresses of the file data or in the physical space in which the data are being stored. An example of such a physical discontinuity is when data of a file fills one block and begins to be written into another block. This is illustrated in FIG. 11, wherein a first data group fills the first block 183 the remaining portion 184 of the file is stored in the second block 185 as a second data group. The first data group can be represented by (F0, D0), where F0 is the logical offset of the beginning of the data file and D0 is the physical location within memory where the file begins. The second data group is represented as (F1, D1), where F1 is the logical file offset of data that is stored at the beginning of the second block 185 and D1 is the physical location where that data are stored.

The amount of data being transferred through the host-memory interface may be expressed in terms of a number of bytes of data, a number of sectors of data, or with some other granularity. A host most often defines data of its files with byte granularity but then groups bytes into sectors of 512 bytes each, or into clusters of multiple sectors each, when communicating with a large capacity memory system through a current logical address interface. This is usually done to simplify operation of the memory system. Although the file-based host-memory interface being described herein may use some other unit of data, the original host file byte granularity is generally preferred. That is, data offsets, lengths, and the like, are preferably expressed in terms of byte(s), the smallest reasonable unit of data, rather than by sector(s), cluster(s) or the like. This allows more efficient use of the capacity of the flash memory storage with the techniques described herein.

In common existing logical address interfaces, the host also specifies the length of the data being written. This can also be done with the file-based interface described herein but since it is not necessary for execution of the Write command, it is preferred that the host not provide the length of data being written.

The new file written into the memory in the manner illustrated in FIG. 11 is then represented in a FIT as a sequence of index entries (F0, D0), (F1, D1) for the data groups, in that order. That is, whenever the host system wants to access a particular file, the host sends its fileID or other identification to the memory system, which then accesses its FIT to identify the data groups that make up that file. The length <length> of the individual data groups may also be included in their individual entries, for convenience of operation of the memory system. When used, the memory controller calculates and stores the lengths of the data groups.

So long as the host maintains the file of FIG. 11 in an opened state, a physical write pointer WP1 is also preferably maintained to define the location for writing any further data received from the host for that file. Any new data for the file are written at the end of the file in the physical memory regardless of the logical position of the new data within the file. The memory system allows multiple files to remain open at one time, such as 4 or 5 such files, and maintains a write pointer for each of them. The write pointers for different files point to locations in different memory blocks. If the host system wants to open a new file when the memory system limit of a number of open files already exists, one of the opened files is first closed and the new file is then opened. After a file has been closed, there is no longer any need to maintain the write pointer for that file.

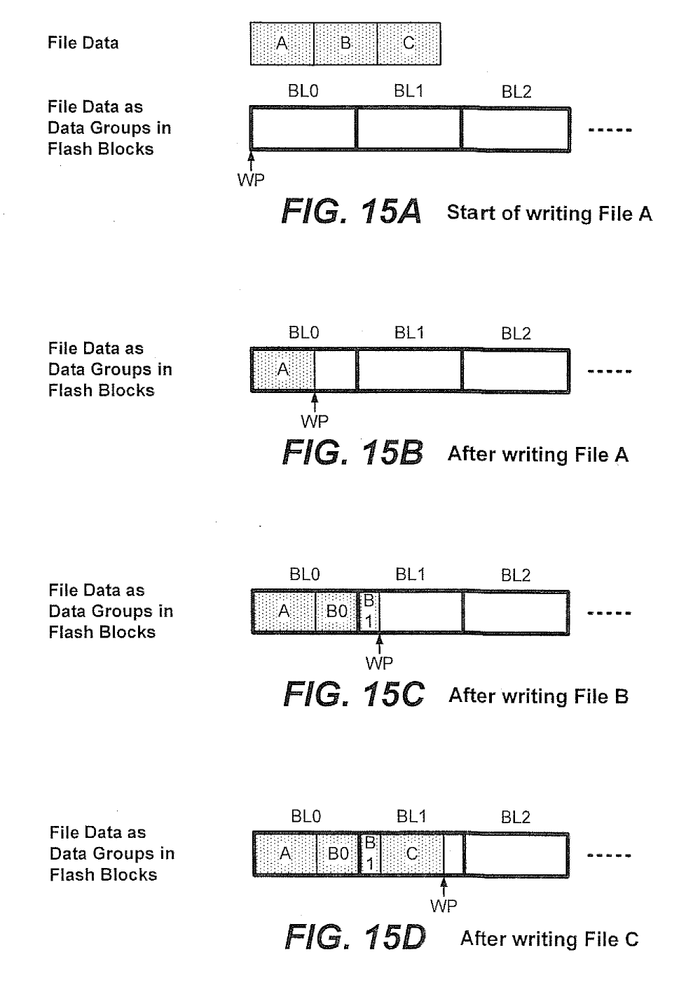

A set of direct file interface commands from the host system supports the operation of the memory system. An example set of such commands is given in FIGS. 12A-12E. These are only briefly summarized here, for reference throughout the remaining portion of this description. FIG. 12A list the host commands used to cause data to be transferred between the host and memory systems, according to a defined protocol. Data within a designated file (<fileID>) at a particular offset (<offset>) within the file is either written to or read from the memory system. Transmission of a Write, Insert or Update command is followed by transmission of data from the host to the memory system, and the memory system responds by writing the data in its memory array. Transmission of a Read command by the host causes the memory system to respond by sending data of the designated file to the host. A data offset need not be sent with the Write command if the memory system maintains a pointer identifying the next storage location where additional data of the file may be stored. However, if a Write command includes an offset address within the file already written, the memory device may interpret that to be a command to update the file data beginning at the offset address, thereby eliminating the need for a separate Update command. For the Read command, a data offset need not be specified by the host if the entire file is to be read. Execution of one of these FIG. 12A data commands is terminated in response to the transmission by the host system of any other command.

Another data command is a Remove command. Unlike the other data commands of FIG. 12A, the Remove command is not followed by the transmission of data. Its effect is to cause the memory system to mark data between the specified offset1 and offset2 as obsolete. These data are then removed during the next data compaction or garbage collection of the file or block in which the obsolete data exits.

FIG. 12B lists host commands that manage files within the memory system. When the host is about to write data of a new file in the memory system, it first issues an Open command and the memory system responds by opening a new file. A number of files that can remain open at one time will usually be specified. When the host closes a file, a Close command tells the memory system that its resources used to maintain the open file can be redirected. The memory system will typically immediately schedule such a file for garbage collection. With the direct file interface being described, garbage collection is logically managed and performed primarily on files, not physically with individual memory cell blocks. The Close_after command gives the memory system advanced notice that a file is about to be closed. The file Delete command causes the memory system to immediately schedule the memory cell blocks containing data from the deleted file to be erased, in accordance with specified priority rules. An Erase command specifies that data of the specified file be immediately erased from the memory.

The primary difference between the Delete and Erase commands is the priority given to erasing the designated file data. The host may use the Erase command to remove secure or sensitive data from the memory at the earliest practical time, while the Delete command causes such data to be erased with a lower priority. Use of the Erase command when powering down the memory system removes sensitive data before the memory device is removed from the host and thus prevents dissemination of that data to other users or host systems during a subsequent use of the memory device. Both of these commands are preferably executed in the background; i.e., without slowing down execution of the primary data commands (FIG. 12A). In any event, receipt of another command from the host will usually cause the memory controller to terminate any background operation.

Host commands that relate to directories within the memory system are listed in FIG. 12C. Each directory command includes an identification (<directoryID>) of the directory to which the command pertains. Although the memory system controller maintains the directories, commands with respect to the directories and designations of the directories are provided by the host system. The memory controller executes these commands, with the host supplied directory designations, pursuant to the firmware stored in the memory system.

The <fileId> parameter can be either a full pathname for the file, or some shorthand identifier for the file, referenced herein as a file_handle. A file pathname is provided to the Direct-File Interface of FIG. 11 in association with certain commands. This allows a fully explicit entry to be created in the file directory when a file is opened for the first time, and allows the correct existing entry in the file directory to be accessed when an existing file is opened. The file pathname syntax may conform to the standard used by the DOS file system. The pathname describes a hierarchy of directories and a file within the lowest level of directory. Path segments may be delimited by “\”. A path prefixed by “\” is relative to the root directory. A path not prefixed by “\” is relative to the current directory. A segment path of “. . . ” indicates the parent directory of the current directory.

Open files may alternatively be identified by a file_handle parameter, which is assigned by the storage device when the file is first created. The storage device can then communicate the shorthand file designation to the host each time the host opens the file. The host may then use the file_handle with the Write, Insert, Update, Read, Close and Close_after commands of an open file. Access to the file by the host will typically be quicker than if a full pathname is used since the hierarchy of the file directory need not be navigated. When a file is first opened by use of the Open command, the full pathname is usually used since a file_handle has likely not yet been assigned to that file by the memory system. But a file_handle can be used if already available. For the remaining Delete and Erase commands of FIGS. 12A and 12B that utilize a fileId, use of a complete file pathname is preferred as security against an incorrect file_handle being supplied by the host. It is more difficult for the host to inadvertently generate an incorrect pathname that matches one of an existing but unintended file.

The directory commands of FIG. 12C are similarly received by the Direct-File Interface of FIG. 11 with a <directoryID> identification of the directory to which they pertain. A full pathname is the preferred directoryID that is received with a directory command.

The file_handle is a shortform identifier that is returned at the Direct-File Interface to the host by the mass storage device in response to an Open command. It is convenient to define the file_handle as being the pointer to the FIT that exists in the directory entry for the file. This pointer defines the logical FIT block number and logical file number within that block for the file. Using this as a file_handle allows the file FIT entries to be accessed without first having to search for the file in the file directory. For example, if the memory device can have up to 64 FIT blocks, and each FIT block can index up to 64 files, then a file with file_handle 1107 has the pointer to its data group entries in the FIT set to logical file 7 in FIT block 11. This file_handle is generated by the memory system controller when directory and FIT entries for a file are created in response to an Open command and becomes invalid in response to a Close command.

FIG. 12D give host commands that manage the state of the interface between the host and memory systems. The Idle command tells the memory system that it may perform internal operations such as data erasure and garbage collection that have previously been scheduled. In response to receiving the Standby command, the memory system will stop performing background operations such as garbage collection and data erasure. The Shut-down command gives the memory controller advance warning of an impending loss of power, which allows completion of pending memory operations including writing data from volatile controller buffers into non-volatile flash memory.

A Size command, shown in FIG. 12E, will typically be issued by a host before a Write command. The memory system, in response, reports to the host the available capacity for further file data to be written. This may be calculated on the basis of available unprogrammed physical capacity minus physical capacity required to manage storage of the defined file data capacity.

When the host issues a Status command (FIG. 12E), the memory device will respond with its current status. This response may be in the form of a binary word or words with different fields of bits providing the host with various specific items of information about the memory device. For example, one two-bit field can report whether the device is busy, and, if so, provide more than one busy status depending upon what the memory device is busy doing. One busy status can indicate that the memory device is dealing with executing a host write or read command to transfer data, a foreground operation. A second busy status indication can be used to tell the host when the memory system is performing a background housekeeping operation, such as data compaction or garbage collection. The host can decide whether to wait until the end of this second busy before sending another command to the memory device. If another command is sent before the housekeeping operation is completed, the memory device will end the housekeeping operation and execute the command.

The host can use the second device busy in combination with the Idle command to allow housekeeping operations to take place within the memory device. After the host sends a command, or a series of commands, that likely creates the need for the device to do a housekeeping operation, the host can send the Idle command. As described later, the memory device can be programmed to respond to an Idle command by initiating a housekeeping operation and at the same time start the second busy described above. A Delete command, for example, creates the need to perform garbage collection, according to the algorithms described below. An Idle command from the host after having issued a series of Delete commands then allows the device time to perform garbage collection that may be necessary for the memory device to be able to respond to a subsequent host Write command. Otherwise, the garbage collection may need to be performed after receiving the next Write command but before it can be executed, thereby significantly slowing down execution of that command.

Thus, the File Storage System described in U.S. patent application Ser. No. 11/060,249 provides mapping of host file data directly to the block structure of flash memory when certain file-related data attributes and notifications are provided by the host. Logical-to-physical block mapping is not used, and data for a file is stored in the order it is received from the host. It provides a more efficient file storage system in place of the numerous prior art file storage systems which were mostly designed for rotating media and are highly inefficient when used with flash memory.

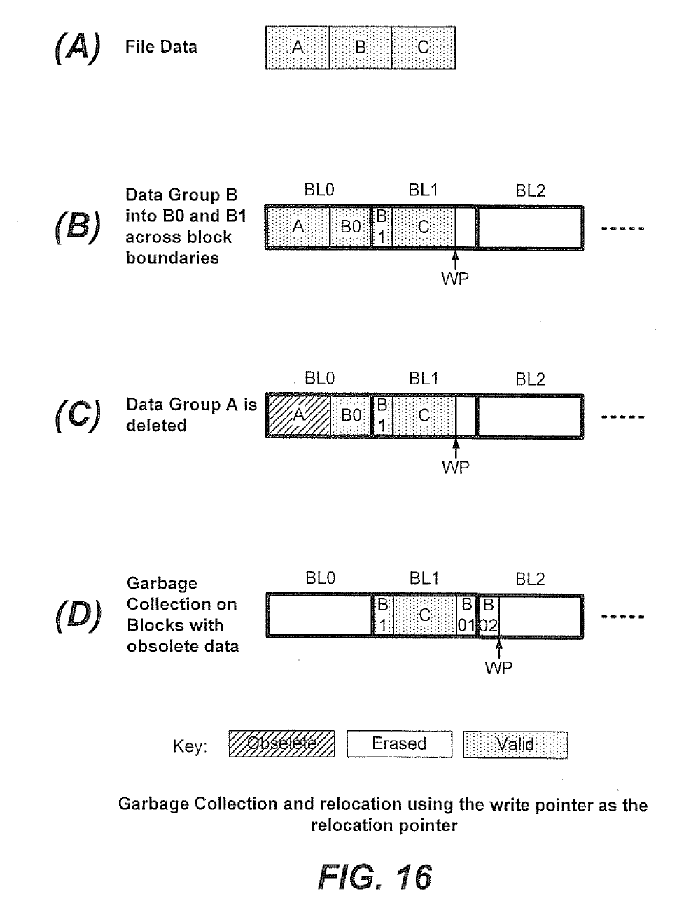

FIGS. 13A and 13B illustrate the allocation scheme of the file storage system described in U.S. patent application Ser. No. 11/060,249. One main feature of this system is the allocation of each file to a new block in the case the file size is not known in advance (which is often the case if the data is being compressed by the host as it writes.)

FIG. 13A illustrates three files A, B and C that are each less than the size of a metablock such as BL0, BL1 and BL2. FIG. 13B illustrate the manner the three files of FIG. 13A are written to memory. The three files are respectively written to separate empty metablocks. Thus, file A is written to BL0, file B to BL1 and file C to BL2. If the host is keeping these files open, each will have a write pointer such as WPA, WPB or WPC to point to the memory location for the next write related to each file. This happens due to the allocation method which puts every new file to a new empty metablock. When the system runs out of empty blocks, it will have to start garbage collection operations in order to free up the space and be able to continue writing.

Thus, small files (smaller than a metablock) and their residual data often have to be garbage collected during write operation if the file's length was not known in advance, even if the card is pre-erased. In the worst case of the small file write sequence the majority of the files has to be written twice because of the need for garbage collection. As the result, the write performance will be halved. In a typical example of a system with 1000 available metablocks of 1 MB each, it will have a total capacity of 1000 MB. If the host writes files each having a size of 200 KB, then in principle the memory can accommodate a maximum of 5000 files. However, because each individual file is written to a new empty block, the first 1000 files (20% of total capacity) will write at the maximum speed, each into an empty block. However, thereafter all the empty blocks are used up and subsequent file writes (up to 4000 files or 80% of total capacity) will be done at a speed less than half of the maximum as every file write will trigger a garbage collection of a previously written file and block erase.

In other words, small files and file fragments cannot be efficiently packed to the memory blocks. In the extreme case, when the host writes files of a size just one bit bigger than half a metablock, the useful device capacity is reduced to 50% of physical capacity.

Such memory allocation method gives priority to the erase commands rather than write commands, as it moves some garbage collection operations from the erase phase to the write phase with the assumption that there will be plenty of time between write commands to perform background garbage collection operation. Unfortunately, if the host is quick to send another command or the power is switched off, there may be no time for background operations and the delayed garbage collections may lead to excessive write command latency and affect write performance.

### DETAILED DESCRIPTION OF PREFERRED EMBODIMENTS

### Memory Allocation for File Data in a Direct File Storage System

According to one aspect of the invention, in a memory system with a file storage system, a scheme for allocating memory locations for a write operation is to write the files one after another in a memory block rather than to start a new file in a new block. When operated over a majority of blocks to be written, this scheme is particularly efficient for files that have a size smaller than that of a block. In this way, they are more efficiently packed into the blocks by being written closely following one after another, even if they belong to different data files.

In a preferred embodiment, multiple write pointers allow multiple files to be concurrently updated. Ideally, there should be at least one write pointer per file that has been opened for updating, but the number of write pointers, or number of write blocks should be limited to some predetermined number. If the number of opened files exceeds a limit, then the next opened file should be written at a write pointer after one of the currently open files.

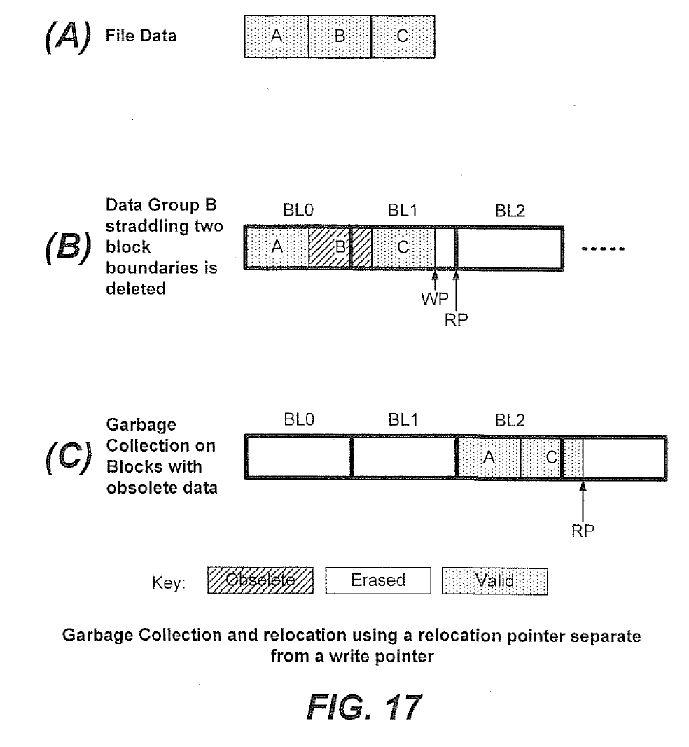

FIG. 14 is a flow diagram illustrating a write operation for direct file system, according to the present invention.

STEP 310: Providing a memory system organized into erasable blocks of memory cells for writing data files created by a host;
STEP 312: Providing an incrementing write pointer to address the location in the memory system where the writing is to perform;
STEP 320: Receiving a current command to write specified data belonging to a data file to the memory system;
STEP 322: Receiving the specified data, the data being specified by a unique file identifier and an offset of data within the identified data file;
STEP 330: Writing the specified data to the memory system without resetting the incrementing write pointer even when the current data file is different from that of a last write;
STEP 340: Are there more writes? If so proceed to STEP 330, otherwise proceed to STEP 350;

### STEP 350: End.

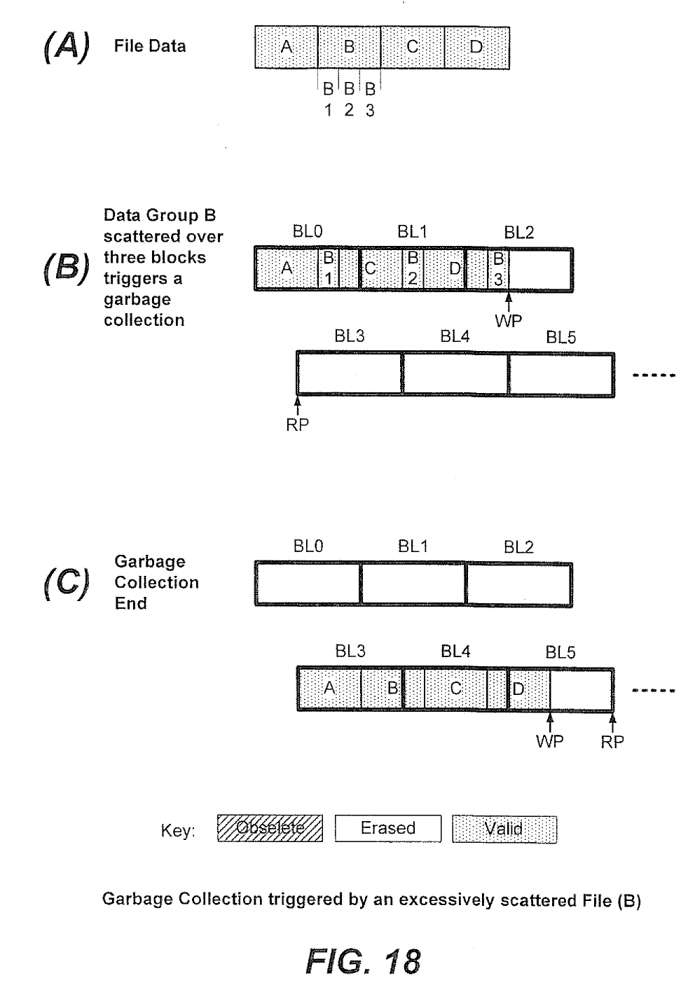

FIGS. 15A-15D illustrate in sequential order an allocation scheme for writing the three example files shown in FIG. 13A, according to the present invention. Data for a file is stored in a chain of flash blocks, where the blocks may be shared with the other files, in the order in which it is provided by the host. An incrementing write pointer WP defines the write location for the next data for a file, which is independent of the offset address of the data within the file. When a current write block becomes filled with file data, an erased block is allocated, and the write pointer is moved to this block. Thus, in writing the files A, B and C, the file A data is located at the beginning of a block, with a second file's data allocated at the incremental Write Pointer so that when the first block gets full, the Write Pointer moves to another block.

FIG. 15A illustrates the state of the write pointer just prior to writing file A. It is positioned at the beginning of an allocated erased block BL0. Such a block allocated for write operation will also be referred to as a write block.

FIG. 15B illustrates the state of the write pointer after writing file A. Prior to writing file A, it is positioned at the beginning of block BL0. The file write command shown in FIG. 12A is executed to write the file A into BL0 in accordance with the incrementing write pointer WP. In this example, after the File A has been written it only partially fills the block BL0. The write pointer WP is positioned in BL0 just after where the write ends.

FIG. 15C illustrates the state of the write pointer after writing file B. It is positioned in block BL0 just after where the last write ended. The file write command is executed to write the file B into the remaining empty space of BL0 in accordance with the incrementing write pointer WP. In this example, the remaining empty space of BL0 can only accommodate a portion B0 of File B and the left-over B1 portion is written to the next allocated erased block BL1. The write pointer WP is positioned in BL1 just after where the write ends.

FIG. 15D illustrates the state of the write pointer after writing file C. It is positioned in block BL1 just after where the last write ended. The file write command is executed to write the file C into the remaining empty space of BL1 in accordance with the incrementing write pointer WP. In this example, the remaining empty space of BL1 can accommodate the entire File C with room to spare. The write pointer WP is positioned in BL1 just after where the write ends.

It will be seen that the contiguous packing scheme shown in FIGS. 15A-15D utilizes the memory more efficiently than that shown in FIG. 13B where every new file is written to a new erased block. Thus in view of the earlier discussion, when the host writes files to an empty card, no garbage collection is required. This is also true for most cases of host file writes after an erase, as most of the garbage collection is performed during erase command execution and not on demand during a write operation due to a lack of erased block.

The write pointer defines the location for the next file data to be written in all cases, including when original data is to be appended to the file, when original data is to be inserted within the existing file, and when existing data is to be updated within the file.

In another embodiment, multiple write pointers allow multiple files to be concurrently updated. Ideally, there should be at least one write pointer per open file, but the number of write pointers, or number of write blocks should be limited to some predetermined number. If the number of open files exceeds the limit, then an open file should be written at a write pointer after one of the currently open files.

In order for the present scheme to implement dense packing of the blocks, mixed blocks is supported. In this case, a mixed block will contain data from more than one file.

In a preferred embodiment, the individual blocks are organized into multiple pages; and file data from each write operation are written to within less than one page following file data written in the last write operation. This is applicable when the data is aligned to a page as will be described in more detail in a later section.

In the case when it is known that the file is bigger than a block, a new write block can be opened to write a file as described in U.S. patent application Ser. No. 11/060,249.

### Garbage Collection

In yet another embodiment, an incrementing relocation pointer points to the write location in memory for the next data for a file to be relocated during a garbage collection or data compaction operation. The garbage collection or data compaction are typically triggered by existence of obsolete data in a block after a file delete or file update operation. It is performed when the number of obsolete blocks exceeds any one of a set of predetermined thresholds. The invention also prescribes that garbage collection is to be triggered if the number of file fragments or residual data portions exceeds a predetermined number, e.g., two. The number of file fragments is the number of blocks storing this file's data with some other file's data. In this way, when a file is deleted, only a limited number of blocks also containing other file's data will need to be garbage collected.

During garbage collection of a closed file, data for valid files is relocated from blocks containing obsolete data. The valid data is relocated to location in another block as designated by a relocation pointer or a write pointer.

Garbage collection is normally triggered by the file erase command (FIG. 12B) or file update command (FIG. 12A) or when the number of blocks containing obsolete data exceeds a predetermined number. These commands results in creating a portion of obsolete data in one or more block. Garbage collection may also be triggered if the number of file fragments or residual data portions exceeds a predetermined number, e.g., two. The number of file fragments is the number of blocks storing this file's data with some other file's data. A portion of file occupying a full block is not considered a fragment. For example, the blocks BL0 and BL1 shown in FIG. 15D each has two file fragments. In the preferred embodiment, if the mixed block has more than two fragments, it may be considered too “mixed”, and is preferably preemptively garbage collected.

In order to have more efficient garbage collection in the case of multiple file erases or updates, the data relocation can be delayed and executed later, provided the device can keep functioning as normal.

It is preferable to perform all garbage collections in foreground, while the device is staying busy, so that multiple garbage collections, as well as garbage collection during write operations can be avoided. That is, garbage collections are preferable done during command execution, such as the erase command. In this way, the worst case (the longest) garbage collection operation can be limited and managed, as well as distribution of garbage collections between commands will become more even. This will avoid the built up of obsolete blocks that will eventually trigger a “garbage collection avalanche”.

A write block can be allocated as a relocation block for data only being copied from the other blocks during garbage collection. The relocation pointer defines the location for the next data to be written. A write block can be shared for the data written by the host as well as the data being copied from the other blocks, especially if the data belongs to the same file, or if the write blocks and Relocation blocks are not separated.

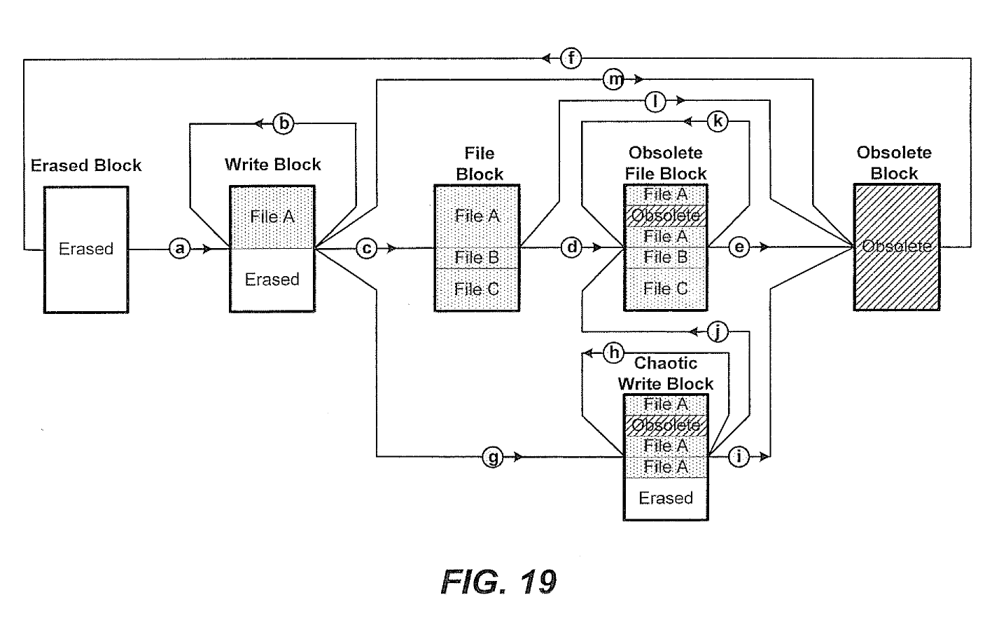

FIGS. 16A-16D illustrate the sequence of example direct-file operations leading to garbage collection with the relocation of valid data designated by a write pointer. In this example, the system is using the same Write Pointer to write and relocate data.

FIG. 16A illustrates the three, to be written example files A, B and C as shown in FIG. 15A. FIG. 16B illustrates the state of the memory blocks after successive writes of the three files, similar to that shown in FIG. 15D. The file B is split into two portions, B0 and B1, written respectively to blocks BL0 and BL1. It will be seen that both blocks BL0 and BL1 have become mixed blocks, each containing file fragments from two different files.

FIG. 16C illustrates the state of the memory blocks after a deletion of file A. File A is deleted by the host. It triggers relocation of the head portion of the file B at the write pointer. The block BL0 now contains obsolete data and need to have its valid data BO relocated before the block can be erased. In this example, the write pointer can serve as the relocation pointer as the data to be relocated is from file B and can be relocated to the block BL1 without increasing the mixture in it. File B has two fragments before and after garbage collection.

FIG. 16D illustrates the state of the memory blocks after a relocation of the valid data in the obsolete block. The block BL0 now contains obsolete data and need to have its valid data B0 relocated before the block can be erased. Thus a portion B01 of B0 fills the remaining space in BL1, while a remaining portion B02 of B0 spills over to the next allocated block BL2. It will be seen the mixed block BL1 initially contains file fragments from files B and C, and after the relocation operation, still contains file fragments from files B and C and no additional files.

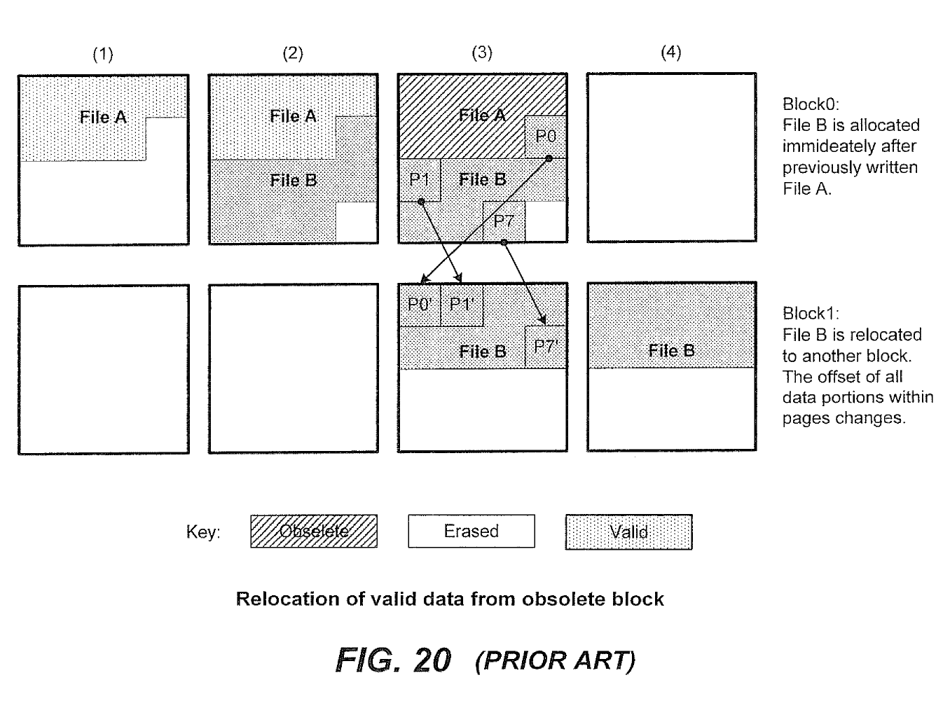

FIGS. 17A-17C illustrate the sequence of example direct-file operations leading to garbage collection with the relocation of valid data designated by a relocation pointer. In this example, the system is using separate write and relocation pointers to write and relocate data.

FIG. 17A illustrates the three, to be written example files A, B and C as shown in FIG. 15A. FIG. 17B illustrates the state of the memory blocks after successive writes of the three files, similar to that shown in FIG. 15D. The file B is split into two portions, written respectively to blocks BL0 and BL1.

FIG. 17C illustrates the state of the memory blocks after a deletion of file B. File B is deleted by the host. Since file B previously straddles the blocks BL0 and BL1, it triggers relocation of files A in BL0 and file C in BL1 at the relocation pointer. After moving the valid data, the first two blocks BL0 and BL1 can be erased.

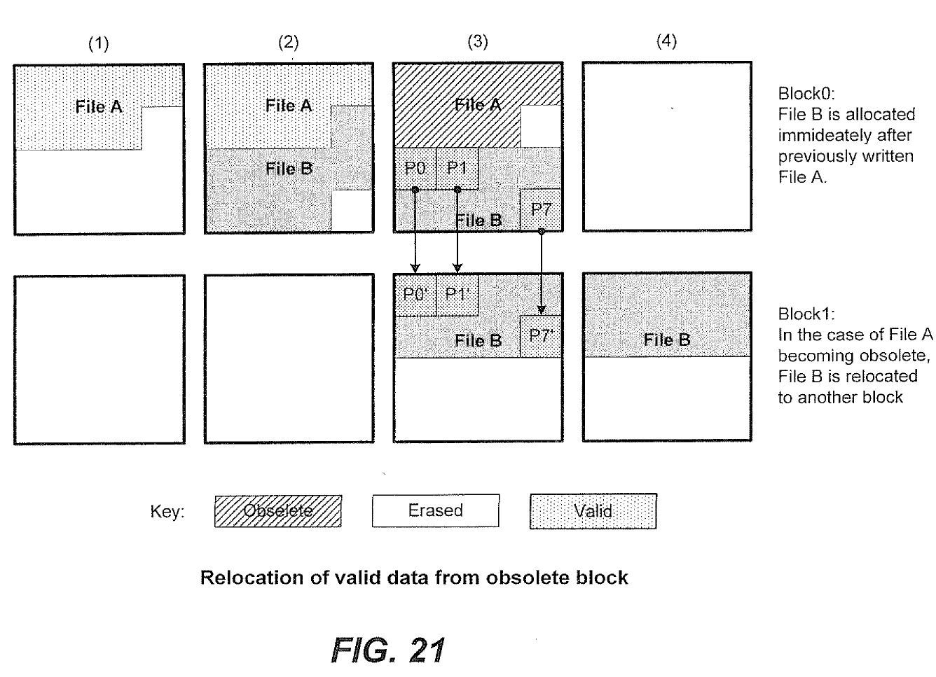

FIGS. 18A-18D illustrate the sequence of example direct-file operations leading to garbage collection triggered by excessive scattering of a file among the blocks. If the number of scattered data portion for a file reaches a threshold, a garbage collection may need to be performed in order to simplify address translation and data handling. In this example, file B got scattered beyond a threshold and a garbage collection is triggered. As discussed earlier, an example threshold for triggering garbage collection is when a file has more than three file fragments.

FIG. 18A illustrates the three, to be written example files A, B and C as shown in FIG. 15A. In particular, the file B has three portions B1, B2 and B3 which are of relevance in FIG. 18B.

FIG. 18B illustrates the state of the memory blocks after successive writes which result in the file B being split into portions B1, B2 and B3, respectively scattered over the three blocks BL0, BL1 and BL2. Since the number of file fragments is over the threshold of two, a garbage collection is triggered at the relocation pointer.

FIG. 18C illustrates the state of the memory blocks after a relocation of all valid data in the blocks containing file B. Thus files A, B, C and D are relocated starting from the block BL3 and extending over to the block BL5. After moving the valid data, the blocks BL0, BL1 and BL2 can be erased.

Generally, a File Storage system can be configured to have a limited number of Write and Relocation Blocks, where a variety of algorithms can be used to optimize the system's performance by making decisions about where some data needs to be written or copied. Such a system include the following features:
Data is normally written at a Write Pointers in one of the partially or fully empty blocks so that write performance stays at the maximum through the write of the entire card as no garbage collection is required during write phase;
File data is always packed optimally to memory blocks, so that during write after erase, the write performance does not depend on file size.
Every file can have up to two fragments so that the files can be optimally packed to memory and the useful device capacity is maximized.
Chaotic Write Blocks allow maintain multiple frequently updated files without excessive garbage collection;
During Garbage collection, the data can be copied at one of the Write Pointer or at one of special Relocation Pointers;
Garbage collection is triggered by file erase or file update;
Garbage collection is preferably performed in the erase command foreground so that multiple garbage collections can be avoided and performance during write phase can be maximized.

### Block States and Transitions

As described earlier, a block is a group of memory cells are as erasable together as a unit. Management of the memory system amounts to block management. In the context of the present scheme, a block may assume one of several state, as in the following:

Erased Block—Block is in the erased state in an erased block pool
Write Block—Block is partially written with valid data for a plurality of files, and further data can be written to it when supplied by the host, or can be copied for the other block(s) during garbage collection
File Block—Block is filled with fully valid data for a plurality of files
Obsolete File Block—Block is filled with any combination of valid data and obsolete data for a plurality of files
Chaotic Write Block—Block is partially written with any combination of valid data and obsolete data for a plurality of files, and further data for the file can be written to it when supplied by the host, or can be copied for the other block(s) during garbage collection
Obsolete Block—Block is partially or fully filled with only obsolete data for a plurality of files

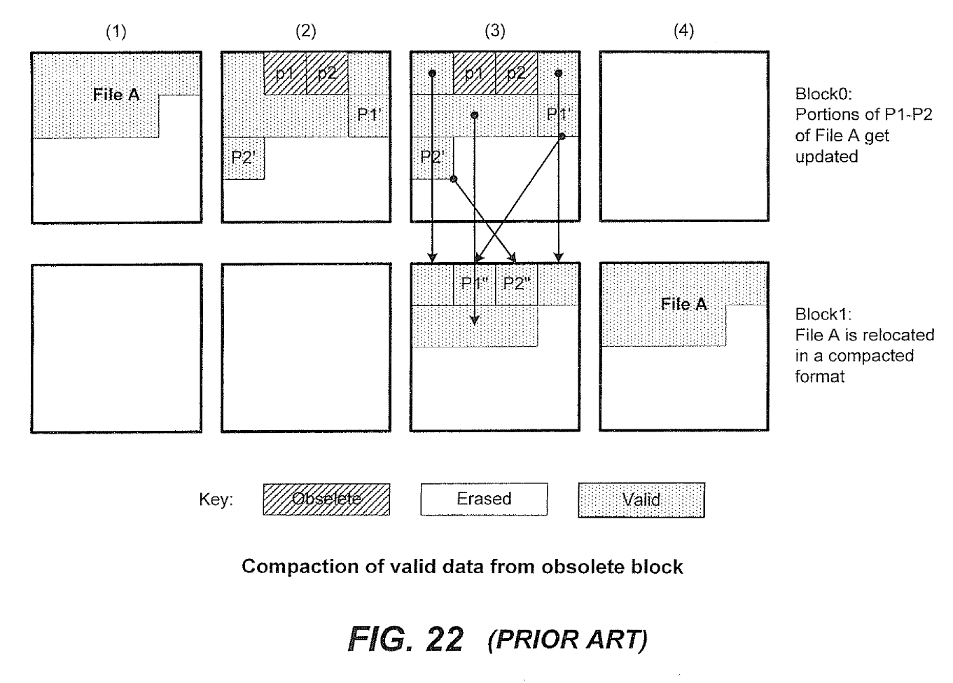

FIG. 19 is a state diagram showing the block transitions from one state to another. For expediency, operations to move entries between elements of the lists or to change the attributes of entries, identified in FIG. 19 as [a] to [m], are as follows:

### [a] Erased Block to Write Block

Data for a file from the host is written to an Erased Block

### [b] Write Block to Write Block

Data for a file from the host are written to a Write Block, or
Data for a files stored in the other block(s) are copied to a Write Block.

### [c] Write Block to File Block

Data for a file from the host are written to fill a Write Block, or
Data for a file stored in the other block(s) are copied to fill a write block.

### [d] File Block to Obsolete File Block

Part of the data in a File Block becomes obsolete as a result of an updated version of the data being written by the host to another block, or
Some but not all of the files, which data are stored in the File Block, being deleted by the host

### [e] Obsolete File Block to Obsolete Block

All of the data in a Obsolete File Block becomes obsolete as a result of an updated version of the data being written by the host to another block, or
All files being deleted by the host, or
All the data being copied to another block during a garbage collection

### [f] Obsolete Block to Erased Block

An Obsolete Block is erased

### [g] Write Block to Chaotic Write Block

Part of the data in a Write Block becomes obsolete as a result of an updated version of the data being written by the host in the same Write Block, or
Part of the data in a Write Block being copied to another block during a garbage collection, or
Some but not all the files, which data are stored in the block, being deleted by the host.

### [h] Chaotic Write Block to Chaotic Write Block

Data for a file from the host is written to an Chaotic Write block, or
Part of the data in a Chaotic Write Block becomes obsolete as a result of an updated version of the data being written by the host to the block, or
Part of the data in a Chaotic Write Block becomes obsolete as a result of some data for a file being copied to another block during garbage collection, or
Some but not all, file being deleted by the host

### [i] Chaotic Write Block to Obsolete Block

All of the data in a Write Block being copied to another block during a garbage collection, or
All the files, which data are stored in the block, being deleted by the host.

### [j] Chaotic Write Block to Obsolete File Block

Data for a file from the host is written to fill an Obsolete Write Block

### [k] Obsolete File Block to Obsolete File Block

Part of the data in a Obsolete File Block becomes obsolete as a result of an updated version of the data being written by the host to another block, or
Some but not all of the files, which data are stored in the File Block, being deleted by the host
Some of the data being copied to another block during a garbage collection

### [l] File Block to Obsolete Block

The only file, which data are stored in the block, being deleted by the host.

### [m] Write Block to Obsolete Block

The only file, which data are stored in the block, being deleted by the host.

The tight pack allocation scheme for writing and relocation described above utilizes memory space more efficiently as compared to the alternative scheme where every new file is started at a new block. The alternative scheme will therefore exhaust the supply of erased block more quickly and any further writes will result in having to first perform garbage collection to free up a new block. This on-demand garbage collection during write will degrade write performance. On the other hand, a collateral effect of the tight pack scheme is the frequent occurrence of mixed blocks where portions of a data file may be scattered over more than one block that also contain other data files. Any obsolescence in one data file can potentially involve garbage collection on a number of mixed blocks in order to salvage valid data belonging to the other data file. The inventive garbage collection scheme is to temper the population of mixed blocks and therefore the amount of garbage collection needed at any one time. The garbage collection can therefore be scheduled during regular erase operations and other foreground memory operations to ensure availability of an erase block during write operations. In this way, the invention provides efficient space allocation and avoidance of on-demand garbage collection during a write operation.

### File Data Alignment In A Direct File Storage System

Typically, an array of memory cells reside on a memory plane and is served Typically, an array of memory cells reside on a memory plane and is served by a set of read/write circuits, which operate on a row of memory cells sharing the same word line. The set of read/write circuits operates on a page of memory cells along the row, where the page may or may not be configured to include all cells in the row. Each block is then accessed page by page. In the general case, when the block is a meta-block formed by linking blocks from multiple planes, a meta-page is form by linking pages from the multiple blocks in the multiple planes to achieved maximum parallelism. The meta-block will be accessed meta-page by meta-page. For the purpose of the present illustration, it suffices to refer to a plane, block and page with the understanding that they also represent multiple planes, meta-block and meta-page.

As described in an earlier section, if files are being deleted or updated by a host, a garbage collection operation is scheduled in order to salvage valid data from the blocks containing obsolete data so that the block could be erased and reused. The valid data is relocated by copying to another block. However, the way data is aligned before and after a memory operation can impact performance and efficiency.

If the data to be copied is aligned to physical pages at the source block and destination block differently, it may lead to additional page reads. On-Chip copy feature cannot be used in this case either. This is because in a typical page read or write, the data for the whole page is transferred out of the data latches for manipulation by the memory controller. This would mean each page is transferred out of the memory chip. However, if the source and destination of the data bit to be copied belong to the same column, then the same read/write circuit will be employed to read the bit and then to write the bit. The data is read into the data latch of the read/write circuit which is then used to write to another row along the same column. No data transfer out of the chip is necessary, thereby saving time and improving copy performance.

Also, if data is not aligned, and a host frequently updates small portion of a file it may cause high data fragmentation leading to excessive amount of indexing information to keep track of the scatter, resulting in a burden to store and maintain the excessive amount of indexing information.

A method for regrouping data read from multi-sector pages inside a memory chip is described in pending United States patent application, entitled “On-Chip Data Grouping and Alignment,” by Sergey A. Gorobets, Ser. No. 11/026,549 filed Dec. 30, 2004.

A memory block management system optimized for operating multiple memory planes in parallel, where each plane is serviced by its own set of read/write circuits is described in pending United States patent application, entitled “Non-Volatile Memory And Method With Memory Planes Alignment,” by Sergey A. Gorobets, publication no. 2005-0141313-A1 published on Jun. 30, 2005.

Data alignment in multi-sector page programming is described in pending United States patent application, entitled “Non-Volatile Memory and Method With Multi-Stream Updating,” by Peter J. Smith, et al, Ser. No. 11/191,686 filed Jul. 27, 2005

The references cited above disclose various methods to address these undesirable issues due to data non-alignment in memory systems. These solutions are for data storage systems that involve a host communicating via logical sectors address with a memory system. The logical sectors are identified by a logical block address (“LBA”) to a certain position within a memory page. No technique addressing the problem in the present direct file storage systems is known.

According to one aspect of the present invention, each portion belonging to a data file is identified by its file ID and an offset along the data file, where the offset is a constant for the file and every file data portion is always kept at the same position within a memory page to be read or programmed in parallel. In this way, every time a page containing a file portion is read and copy to another page, the data in it is always page-aligned, and each bit within the file portion can always be manipulated by the same sense amplifier and same set data latches within the same memory column.

In a preferred implementation, the page alignment is such that (offset within a page)=(data offset within a file) MOD (page size).

In a preferred embodiment, when a page is written with page-aligned file data portion, gaps may exist before or after the file data portion. These gaps can be padded with any existing page-aligned valid data. This is equivalent to rounding up the physical file size.

Thus, in the case of data update or garbage collection every data portion remains at the same position with the physical page. When the data portions are page-aligned, data relocation time is minimized due to reducing the number of page reads during garbage collection.

It allows using the On-Chip copy feature, pipelining data copy in multi-chip configuration, and reduces the worst case garbage collection latency by limiting data fragmentation in memory. When the data is page-aligned, a logical page of data will be copied to a physical page as compared to non-aligned data where a logical page may be distributed over two physical pages. Thus, page-alignment also helps to avoid read or programming two physical pages to manipulate one page of logical data.

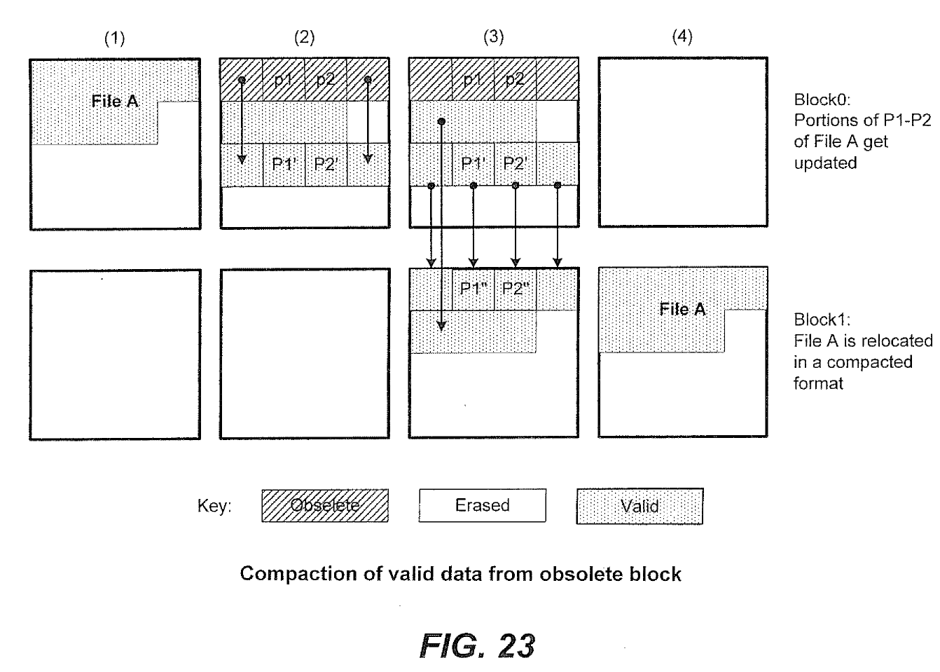

FIG. 20 illustrates a page-non-aligned relocation of a data file from one block to another according to a conventional method. There are four columns (1)-(4), each showing the states of Block0 (top) and Block1 (bottom) after a memory operation.

In column (1), file A is written to Block0 from the starting address of the block. For the purpose of illustration, assume each block has four pages and file A occupies 1.75 pages, filling the four slots of a first page and the first three slots of a second page in Block0. In column (2), file B is written to Block0 appending to where the last write ends. File B has a size that occupies two pages and therefore leaves a gap of 0.25 page at the end of the last page. In column (3), file A is deleted by the host and therefore Block0 now contains obsolete data and is scheduled for a garbage collection in which the remaining valid data, file B will be relocated to free up Block0. File B is copied to Block1, however, the offsets of all data portions within the pages change. This can be seen by examining portions P0′, P1′ and P7′ before and after the copying. Before the copying, P0′ is at the last slot of a page and P1′ that follows P0′ is located at the first slot of a page. The file portion P7′ which is the last portion of file B is located at the third slot of a page. When the file B is copied to an empty Block1, P0′ and P1′ will be written to the first two slots of the first page, while P7′ will be written to the last slot of the second page. Thus, it is evident the file portions no longer reside in the same position relative to a page. Finally in column (4), the fully relocated file B is shown to occupy the first two pages of block1.

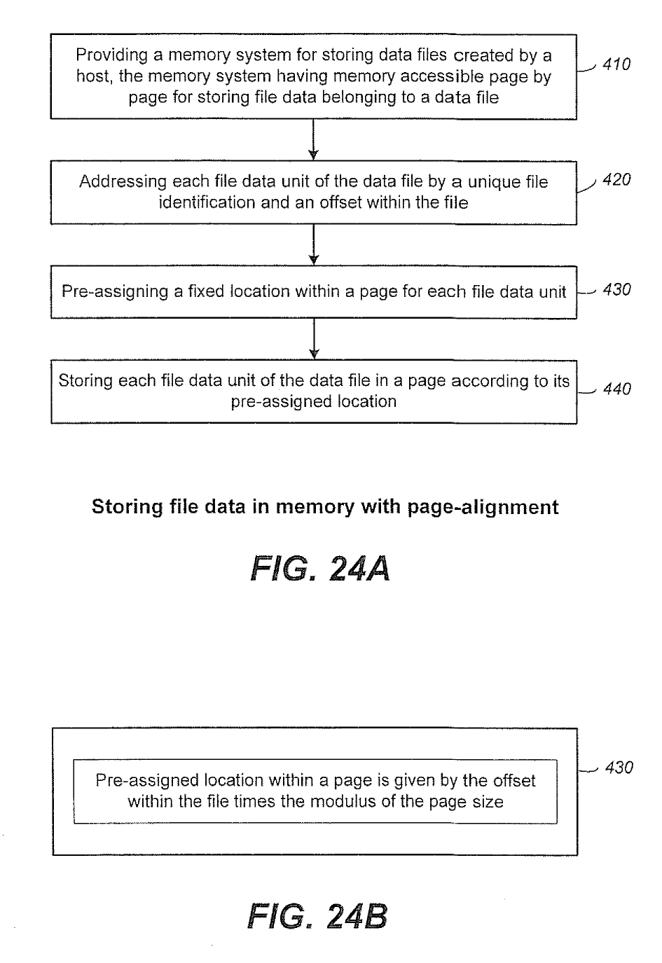

FIG. 21 illustrates a page-aligned relocation of a data file from one block to another according to a preferred embodiment of the present invention. There are four columns (1)-(4), each showing the states of Block0 (top) and Block1 (bottom) after a memory operation.

In column (1), file A is written to Block0 from the starting address of the block. In column (2), file B is written to Block0 but aligned to the page. Again, File B has a size that occupies two, so the beginning of file B starts from the beginning of a page. Thus, it is written from the beginning of the third page all the way to the end of the last page in Block1. In column (3), file A is deleted by the host and therefore Block0 now contains obsolete data and is scheduled for a garbage collection in which the remaining valid data, file B will be relocated to free up Block0. File B is copied to Block1, while maintaining page alignment so that all data portions within the pages does not change. This can be seen by examining portions P0, P1 and P7 before and after the copying. Before the copying, P0 is at the beginning slot of a page and P1′ follows P0′ in the second slot. The file portion P7 which is the last portion of file B is located at the last slot of a page. When the file B is copied to an empty Block1, P0′ and P1′ will be written to the first two slots of the first page, while P7′ will be written to the last slot of the second page as before. Thus, it is evident all file portions reside in the same position relative to a page before and after the copying. Finally in column (4), the fully relocated file B is shown to occupy the first two pages of block1.

Another memory operation that may copy file portion from one block to another is file data compaction. This can occur after a file data update operation that introduces multiple version of the same data portion in the same block. The compaction copies the latest versions to another block, thereby freeing the current block for erase.

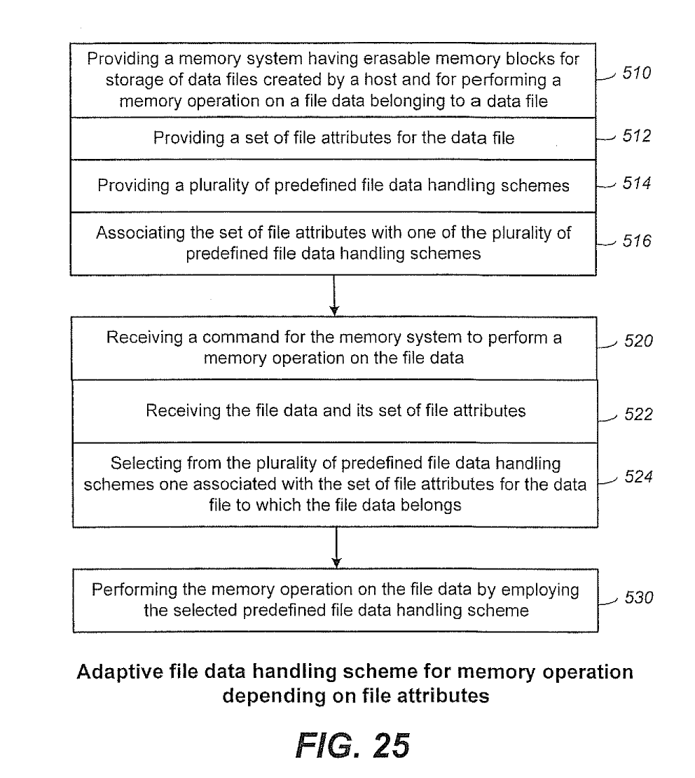

FIG. 22 illustrates a page-non-aligned compaction of a data file from one block to another according to a conventional method. There are four columns (1)-(4), each showing the states of Block0 (top) and Block1 (bottom) after a memory operation.

In column (1), file A is written to Block0 from the starting address of the block. For the purpose of illustration, assume each block has four pages and file A occupies 1.75 pages, filling the four slots of a first page and the first three slots of a second page in Block0. In column (2), an update operation updates file A with new versions for data portions P1 and P2 respectively occupying the second and third slots of the first page. The updated versions P1′ and P2′ is written to the next available location in the same Block0, which is the last slot of page 2 and the first slot of page 3 respectively. Since Block0 now contains obsolete data P1 and P2, it is scheduled for a compaction operation in which the remaining valid data of file A will be relocated to free up Block0. In column (3), all valid data of File A is copied to Block1, however, the offsets of all data portions within the pages change. This can be seen by examining portions P1′ and P2′ before and after the copying. Before the copying, P1′ is at the last slot of the second page and P2′ follows at the first slot of the third page. When all the valid data of file A is copied to an empty Block1, the copying will start from the beginning of the first page in Block1. Therefore, P1′ and P2′ will be written to the second and third slots of the first page. Thus, it is evident some of the file portions have to be copied across columns. Finally in column (4), the fully compacted file A is shown to occupy block1 as originally appeared in Block0 as show in column (1).

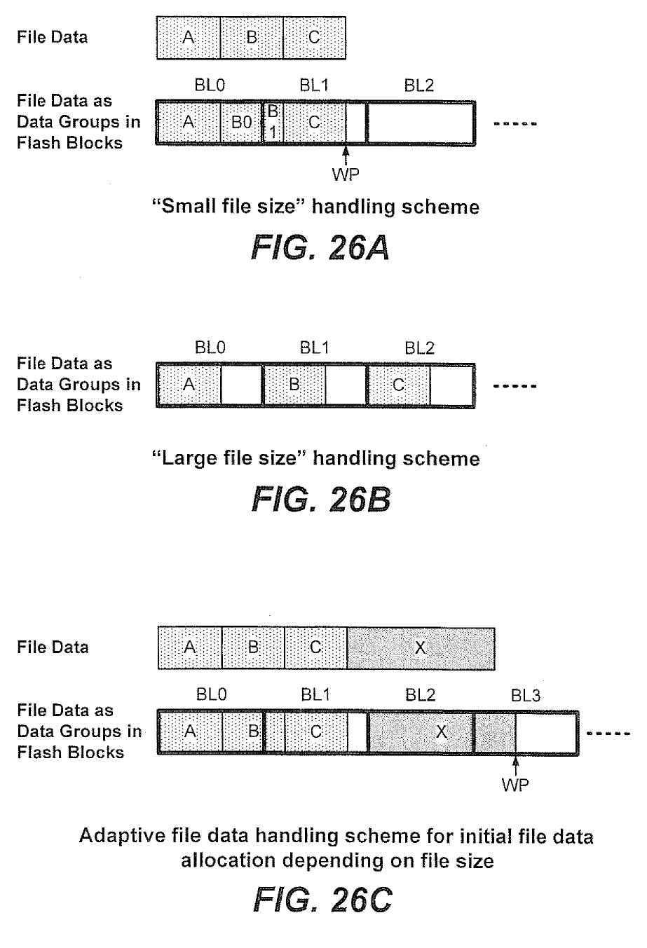

FIG. 23 illustrates a page-aligned compaction of a data file from one block to another according to a preferred embodiment of the present invention. There are four columns (1)-(4), each showing the states of Block0 (top) and Block1 (bottom) after a memory operation.

In column (1), file A is written to Block0 from the starting address of the block. In column (2), an update operation updates file A with new versions for data portions P1 and P2 respectively occupying the second and third slots of the first page. The updated versions P1′ and P2′ is written to the next available location in a page-aligned manner in the same Block0. Thus, they are written respectively to the second and third slots of the third page. However, this leaves a gap in the first and last slot of the third page. In the preferred embodiment, the gaps are padded with existing valid data for that data location. Thus, the first gap is padded with P0′ and the last gap is padded with P3′. This will render the first page of B0 obsolete and a compaction operation is scheduled in which the valid data of file A will be relocated to free up Block0. In column (3), all valid data of File A is copied to Block1, while maintaining page alignment for all of its data portions. This is evident by examining portions P0′, P1′, P2′ and P3′ before and after the copying. Finally in column (4), the fully compacted file A is shown to occupy block1 as originally appeared in Block0 as show in column (1).

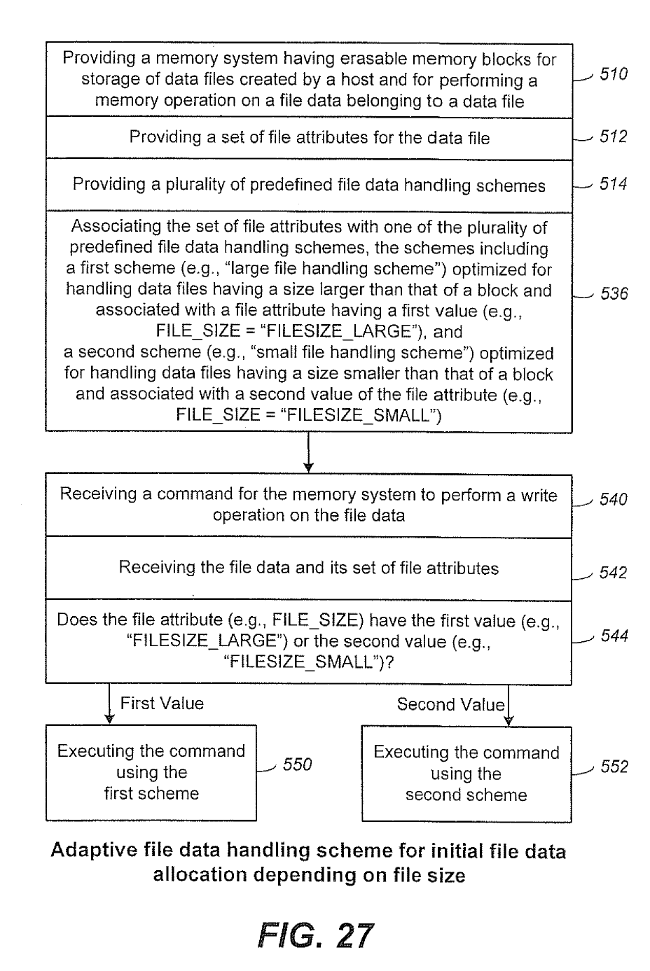

FIG. 24A is a flow diagram illustrating storing file data in memory with page-alignment, according the present invention.

STEP 410: Providing a memory system for storing data files created by a host, the memory system having memory accessible page by page for storing file data belonging to a data file;
STEP 420: Addressing each file data unit of the data file by a unique file identification and an offset within the file;
STEP 430: Pre-assigning a fixed location within a page for each file data unit; and
STEP 440: Storing each file data unit of the data file in a page according to its pre-assigned location.

FIG. 24B is prescription for page alignment of a data file, according a preferred embodiment of the present invention. In a preferred implementation, the STEP 430 is pre-assigning a fixed location within a page for each file data unit, where the pre-assigned location within a page is given by the offset within the file times the modulus of the page size.

### Adaptive File Data Handling In A Direct File Storage System

In earlier sections, two different file data handling methods for direct file system have been described.

The first one, described in U.S. patent application Ser. No. 11/060,249, prescribes storing every file's data starting from the beginning of a new erased block. In other words, the write pointer is reset to the beginning of a new block every time a new file is written. Allowing a block to contain only data from one file helps simplify the management of the blocks. However, this scheme does not pack files efficiently especially when the files typically have sizes less than that of a memory block. For expediency, this first scheme will hereinafter be referred to as the “large file size handling scheme”.

In contrast, the second file data handling scheme, hereinafter to be referred to as the “small file size handling scheme”, has been described in connection with FIGS. 14-19. In this scheme, the write pointer is not reset to the beginning of a new block every time a new file is written. Data from a file is being written to a block according to an incrementing write pointer. When the block becomes full, the write pointer moves to another block. This scheme packs files to blocks efficiently and provides fast write performance to an initially erased memory. However, it produces files that are more scattered among mixed blocks, where each mixed block contains a mixture of data from different files. When one of the scattered files is deleted, it can render more than one block obsolete, thereby increasing the number garbage collection.

In practical situations, files of different sizes exist and optimization can not be achieved by exclusively employing either the large file handling scheme or the small file handling scheme.

Additionally, other different data handling schemes may each be exclusively optimized for a particular type of file or file of a particular attribute. For example, files that are updated frequently may be handled differently from ones that remain essentially static. Thus, if only one file handling scheme is used at all times, it will compromise the performance for those files it is not optimized for.

Thus it can be seen that a file storage system that does not handle files with different characteristics differently will have adopt a compromise handling method. An example system, PDA or mobile phone, writes files containing photographs, thumbnail images, index files, and frequently updates address book and personal files. The main difference between the files would be in size and pattern of updates and accesses. The “compromise” handling method is likely to make it impossible to combine good performance and memory usage as no file storage method can be equally efficient to handle files with different size and access patterns.

According to another aspect of the invention, in a memory system with a file storage system, an optimal file handling scheme is adaptively selected from a group thereof based on the attributes of the file being handled. The file attributes may be obtained from a host or derived from a history of the file had with the memory system.

In a preferred embodiment, a scheme for allocating memory locations for a write operation is dependent on an estimated size of the file to be written. If the files have a size smaller than that of a block, they are more efficiently packed into the blocks by being written contiguously one after another. If the files have a size larger than that of a block, each file is preferably written to a new block.

In another preferred embodiment, a scheme for allocating memory locations for a relocation operation, such as for garbage collection or data compaction, is dependent on an estimated access frequency of the file in question. If the file data belonging to a file that is frequently accessed, they are relocated to a block that collect file data with similar file attributes. Likewise, if the file data belonging to a file that is relatively infrequently accessed, they are relocated to a block to collect file data with similar file attributes.

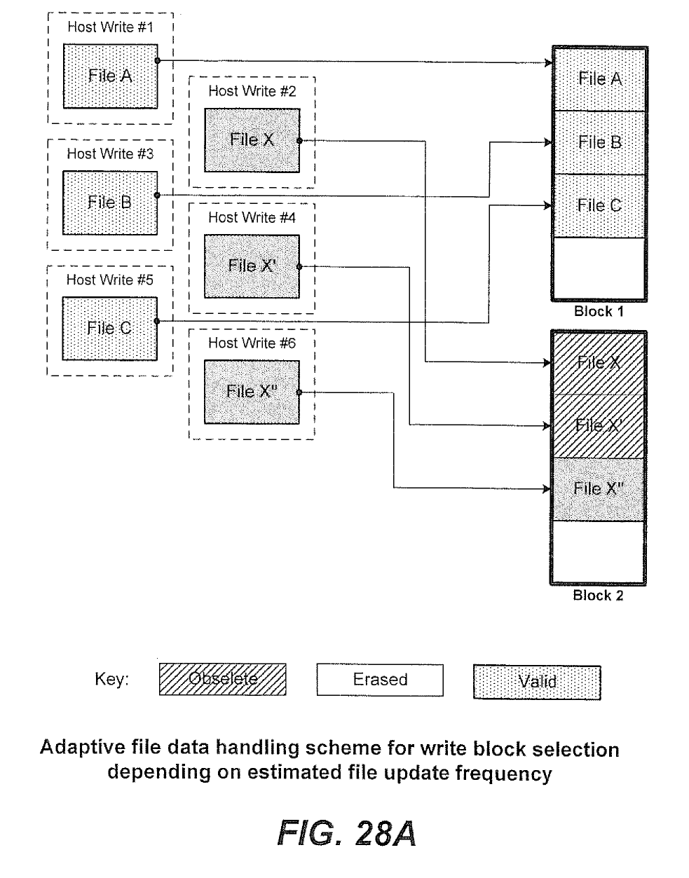

FIG. 25 is a flow diagram illustrating the adaptive file data handling scheme depending on file attributes, according the present invention.

STEP 510: Providing a memory system having erasable memory blocks for storage of data files created by a host and for performing a memory operation on a file data belonging to a data file;
STEP 512: Providing a set of file attributes for the data file;
STEP 514: Providing a plurality of predefined file data handling schemes;
STEP 516: Associating the set of file attributes with one of the plurality of predefined file data handling schemes;
STEP 520: Receiving a command for the memory system to perform a memory operation on the file data;
STEP 522: Receiving the file data and its set of file attributes;
STEP 524: Selecting from the plurality of predefined file data handling schemes one associated with the set of file attributes for the data file to which the file data belongs; and
STEP 530: Performing the memory operation on the file data by employing the selected predefined file data handling scheme.

Two memory operations can particularly benefit from selecting the best file handling scheme based on file attributes. The write operation can employ one scheme optimized for large size file and another optimized for small size files. The relocation operation can employ one scheme for keeping in the same block (e.g. sequential block) file data belonging to files that are known or estimated to be updated infrequently. The relocation operation can also employ another scheme for keeping in the same block (e.g. chaotic block) file data belonging to files that are known or estimated to be updated frequently. Thus, file size and file access frequency are two of the more interesting file attributes that can be used by the adaptive scheme. Some examples of file attributes useful for adaptively selecting a file data handling scheme are as follows:
Multiple vs. single copy of the files stored in the partially obsolete block;
Host marked some files as “cold” or “archive”;
Host defined attribute (file extension/type);
Different update pattern detected by the system in the past;
Size;
Difference in data modifications performed on the data by the host or by the data storage system itself (encrypted vs. non-encrypted data, compressed vs. uncompressed);
Originated by different applications (different SD application byte, user ID etc);
Originated by different hosts (different SD application byte, user ID etc);
Written by different access commands in a dual interface system, file interface vs. logical interface.

Many of these attribute examples essentially reduce down to give information about the file size and the file update frequency. Based on these file attributes, the optimal data handling scheme can be selected for every file in a given memory operation, such as initial file data allocation, garbage collection and file data indexing.

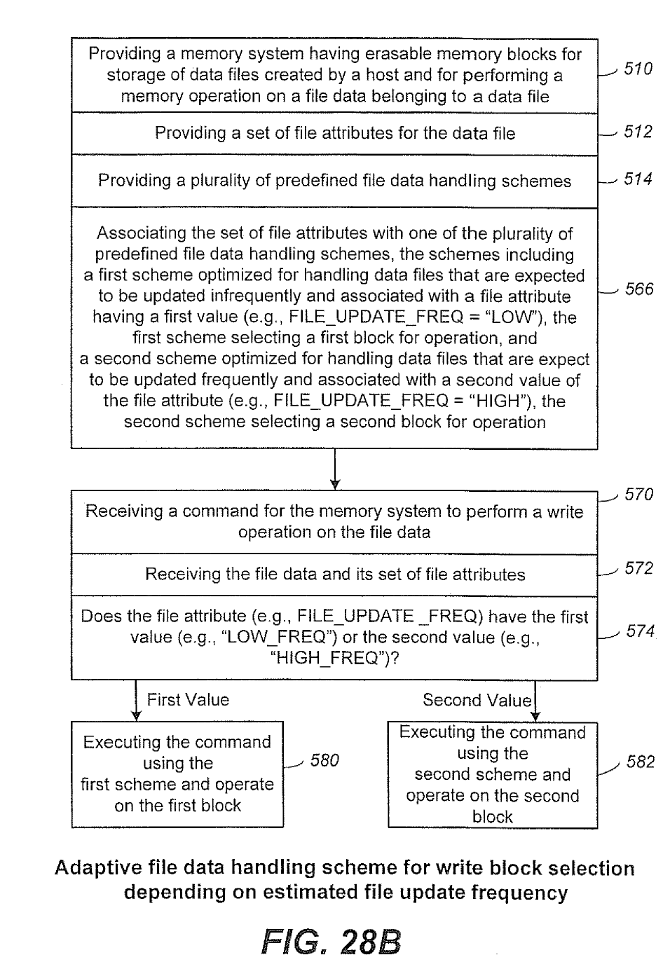

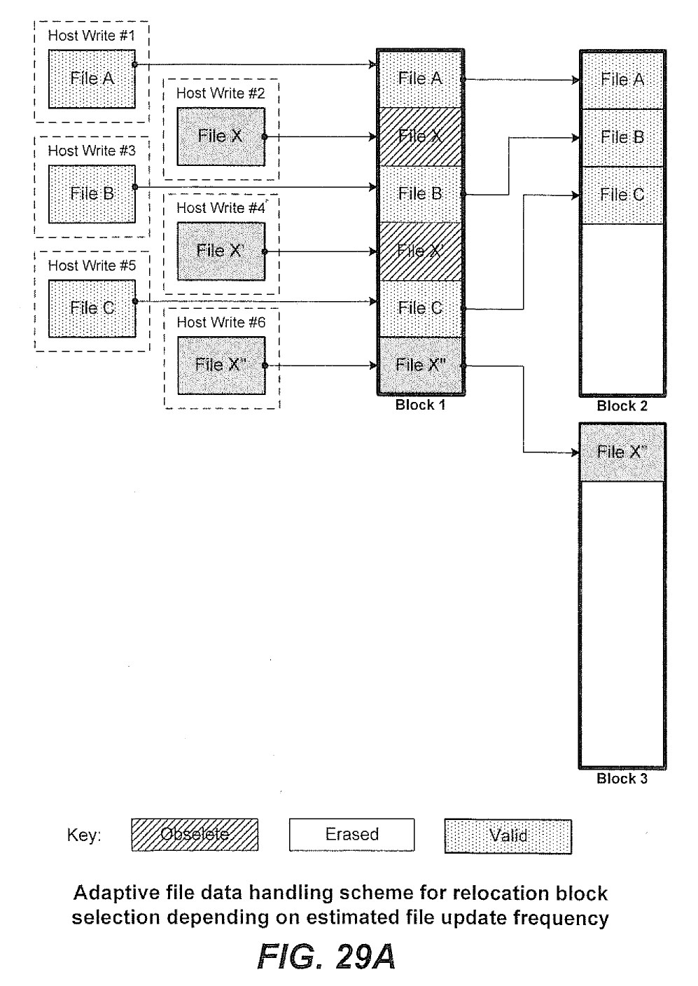

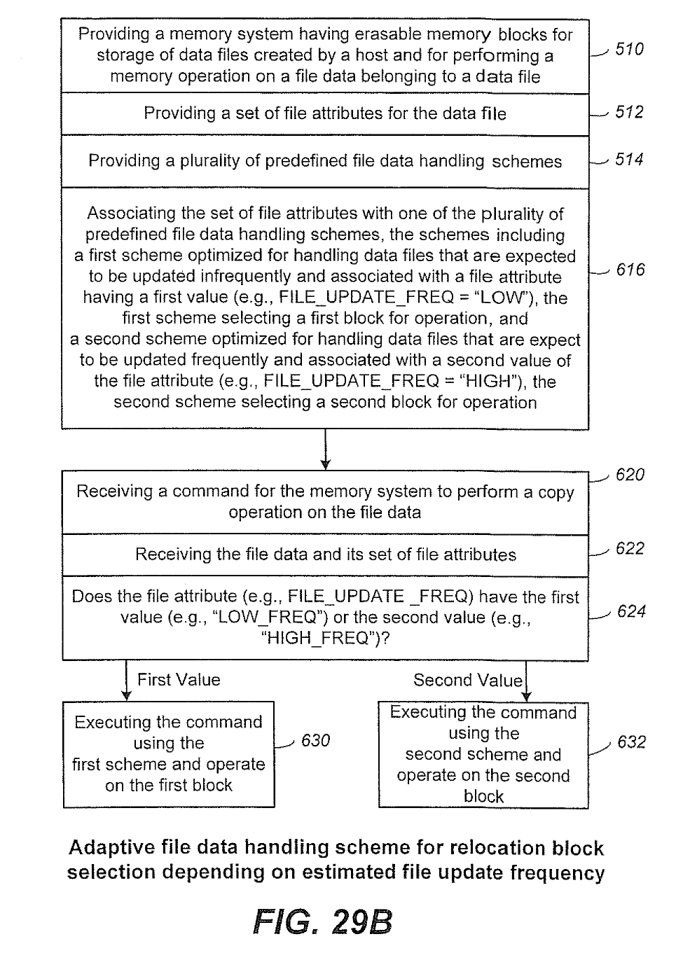

Examples of files with different attributes and how they are handled by an adaptive file data handling method are illustrated in FIGS. 25-28. In particular, FIGS. 25A-25D illustrate the adaptive file data handling scheme for initial file data allocation depending on the file attribute indicating file size, according to a preferred embodiment of the present invention. FIGS. 26A-26B illustrate the adaptive file data handling scheme for write block selection depending on the file attribute indicating estimated file update frequency, according to a preferred embodiment of the present invention. FIGS. 27A-27B illustrate the adaptive file data handling scheme for relocation block selection depending on the file attribute indicating estimated file update frequency, according to a preferred embodiment of the present invention. FIGS. 28A-28B illustrate the adaptive file data handling scheme for both write block and relocation block selection, depending on the file attribute indicating estimated file update frequency, according to a preferred embodiment of the present invention.

Generally, there is a variety of file data handling schemes to select from, and each scheme has different characteristics regarding handling of files with different attributes. As soon as the file attributes become known through analysis or are passed by the host, an optimal selection can be made.

FIG. 26A illustrates the allocation scheme for writing three example files, according to the “small file size handling scheme”. It essentially results from the sequence of writes described in connection of FIGS. 15A-15D. Data for a file is stored in a chain of flash blocks, where the blocks may be shared with the other files, in the order in which it is provided by the host. An incrementing write pointer WP defines the write location for the next data for a file, which is independent of the offset address of the data within the file. When a current write block becomes filled with file data, an erased block is allocated, and the write pointer is moved to this block. Thus, in writing the files A, B and C, the file A data is located at the beginning of a block, with a second file's data allocated at the incremental Write Pointer so that when the first block gets full, the Write Pointer moves to another block.

The small file size handling scheme is, as the name implies, preferable for handling files that typically have a size that is less than that of a block. In this way, one have of tight packing of smaller files, among other benefits described earlier.

FIG. 26B illustrates another allocation scheme for writing the same three example files shown in FIG. 26A, according to the “large file size handling scheme”. It essentially results from the sequence of writes described in connection of FIGS. 13A-13B. The three files are respectively written to separate empty blocks. Thus, file A is written to BL0, file B to BL1 and file C to BL2. If the host is keeping these files open, each will have a write pointer such as WPA, WPB or WPC to point to the memory locate for the next write related to each file. This happens due to the allocation method which puts every new file to a new empty block.

The large file size handling scheme is, as the name implies, preferable for handling files that typically have a size much larger than that of a block. Any unused gap in a block after file ends will be smaller compare to the overall block occupancy by the file. In this way, one has simplified block management with minimum penalty on space wastage.

FIG. 26C illustrate an adaptive allocation scheme for optimally writing files of all sizes, according to a preferred embodiment. Files A, B and C have a size smaller than that of a block while file X have a size larger than that of a block. The adaptive scheme can switch from one scheme to another. In the example illustrated, the file storage system writes files A, B and C, (e.g., small photo image files), using the small file size handling scheme of FIG. 26A, and then the host writes file X which has a different attribute, (e.g., large video or MP3 files), using the above-mentioned large file size handling scheme. Thus, the system's efficiency in terms of performance and memory usage is maximized.

In the adaptive scheme, the smaller size files, such as files A, B and C are written using the small file size handling scheme. Thus, they are written contiguously along a memory space formed by chained blocks such as BL0 and BL1. After, writing each file, the write pointer WP increments without skipping to the next address, even across chained block boundaries. In the example, at the end of writing file C, the block BL1 is only partially filled. In the next write for the file X, it is determined to be a “large size” file. The “large file size handling scheme” is invoked. Thus, the write pointer is made to jump to the beginning of the next empty block, which is BL2. The file X is then written starting from this address into BL2 and extending to the next block BL3.

FIG. 27 is a flow diagram illustrating the adaptive file data handling scheme depending on file size as an example file attribute, according to a preferred embodiment of the present invention.

STEP 510: Providing a memory system having erasable memory blocks for storage of data files created by a host and for performing a memory operation on a file data belonging to a data file;
STEP 512: Providing a set of file attributes for the data file;
STEP 514: Providing a plurality of predefined file data handling schemes;
STEP 536: Associating the set of file attributes with one of the plurality of predefined file data handling schemes, the schemes including a first scheme (e.g., “large file handling scheme”) optimized for handling data files having a size larger than that of a block and associated with a file attribute having a first value (e.g., FILE_SIZE=“FILESIZE_LARGE”), and a second scheme (e.g., “small file handling scheme”) optimized for handling data files having a size smaller than that of a block and associated with a second value of the file attribute (e.g., FILE_SIZE=“FILESIZE_SMALL”);
STEP 540: Receiving a command for the memory system to perform a write operation on the file data;
STEP 542: Receiving the file data and its set of file attributes;
STEP 544: Does the file attribute (e.g., FILE_SIZE) have the first value (e.g., “FILESIZE_LARGE”) or the second value (e.g., “FILESIZE_SMALL”)? If it has the first value, proceed to STEP 550; if it has the second value, proceed to STEP 552.
STEP 550: Executing the command using the first scheme.
STEP 552: Executing the command using the second scheme

FIG. 28A illustrates the adaptive file data handling scheme for write block selection depending on a file attribute indicating estimated file update frequency, according to a preferred embodiment of the present invention. Files (or data blocks) with different attributes can be written to different write blocks. FIG. 28A illustrates an example when a host writes data in two interleaved streams and based on the file attributes select which data go to which stream. The first stream is writing to store files in sequential order in Block1 while the second stream is writing different versions of a frequently updated file to Block2. In the example, the files A, B, and C are assigned to the first stream, while the file X and its updated versions X′ and X″ are assigned to the second stream. In host writes #1, #3 and #4, the files A, B, and C are respectively written to Block1. On the other hand, in host writes #2, #4 and #6, X, X′ and X″ are respectively written to Block2.

In another example (not shown) the second stream can include files X, Y, Z of a type different from A, B, C.

Thus, when the files have different attributes (as information provided by the host), or as soon as the difference in files' attributes is detected (in this case the main difference is obviously the access pattern), the files which belong to different streams can be handled differently by being allocated to different write blocks.

FIG. 28B is a flow diagram illustrating the adaptive file data handling scheme depending on a file attribute indicating estimated file update frequency, according to a preferred embodiment of the present invention.

STEP 510: Providing a memory system having erasable memory blocks for storage of data files created by a host and for performing a memory operation on a file data belonging to a data file;
STEP 512: Providing a set of file attributes for the data file;
STEP 514: Providing a plurality of predefined file data handling schemes;
STEP 566: Associating the set of file attributes with one of the plurality of predefined file data handling schemes, the schemes including a first scheme optimized for handling data files that are expected to be updated infrequently and associated with a file attribute having a first value (e.g., FILE_UPDATE_FREQ=“LOW”), the first scheme selecting a first block for operation, and a second scheme optimized for handling data files that are expect to be updated frequently and associated with a second value of the file attribute (e.g., FILE_UPDATE_FREQ=“HIGH”), the second scheme selecting a second block for operation;
STEP 570: Receiving a command for the memory system to perform a write operation on the file data;
STEP 572: Receiving the file data and its set of file attributes;
STEP 574: Does the file attribute (e.g., FILE_UPDATE_FREQ) have the first value (e.g., “LOW_FREQ”) or the second value (e.g., “HIGH_FREQ”)? If it has the first value, proceed to STEP 580; if it has the second value, proceed to STEP 582.
STEP 580: Executing the command using the first scheme and operate on the first block.
STEP 582: Executing the command using the second scheme and operate on the second block.

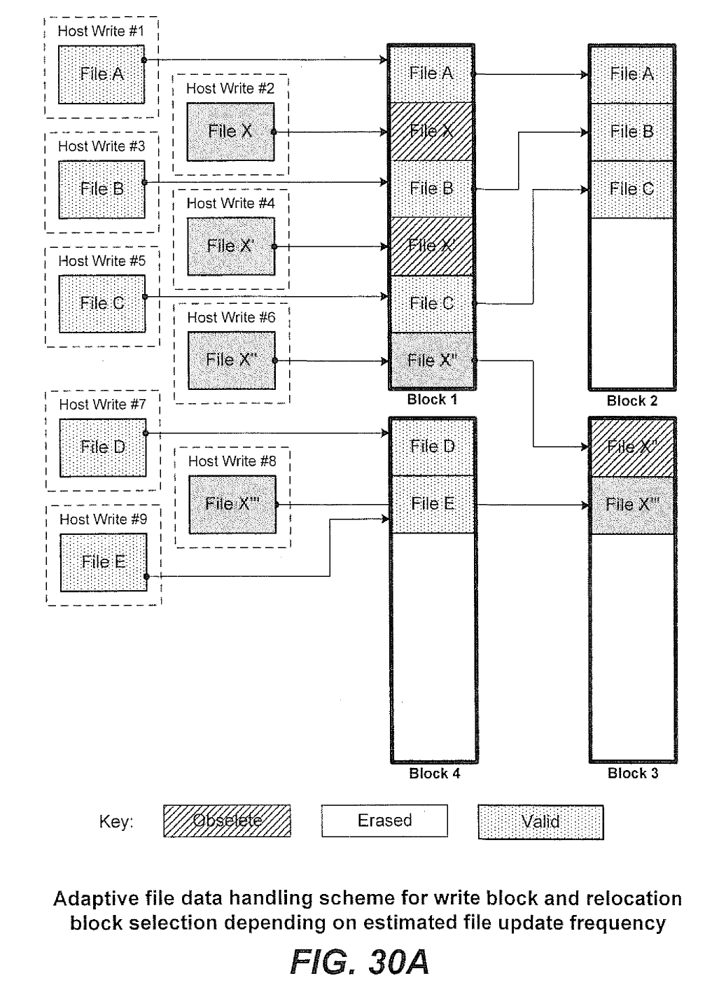

FIG. 29A illustrates the adaptive file data handling scheme for relocation block selection depending on a file attribute indicating estimated file update frequency, according to a preferred embodiment of the present invention. Files (or data blocks) with different attributes can be copied from an obsolete block to different relocation blocks. FIG. 29A illustrates an example when a host writes data to an update block Block1 that eventually contains obsolete data. In a consolidation operation, valid data from the update block is copied to either one of two relocation blocks Block2 and Block3.

In particular, in a series of host writes #1-#6, files A, B, C and different versions of file X are written to the update block Block1. The latest version X″ of file X will render all pervious versions, X and X′ obsolete. When Block1 has its valid data consolidated, files A, B, and C, and the latest version X″ of file X are copied to other blocks. The adaptive file data handling scheme directs the copying of the different files to different relocation blocks based on their file attributes. In this example, the files A, B, and C have one or more file attributes that indicate they are likely to be updated infrequently compared to file X. Thus, the files A, B, and C are directed to a block Block2 that is slated for storing files in sequential order. The latest version X″ of file X is directed to another block Block3 that is slated for storing files that are likely to be updated. In this way, separate blocks can be maintained for both files that are infrequently updated and those that are frequently updated.

Thus, when the files have different attributes, or as soon as the difference in files' attributes is detected (in this case the main difference is obviously the access pattern), the files which have different attributes can be handled differently by being relocated to different relocation blocks.

FIG. 29B is a flow diagram illustrating the adaptive file data handling scheme depending on a file attribute indicating estimated file update frequency, according to a preferred embodiment of the present invention.

STEP 510: Providing a memory system having erasable memory blocks for storage of data files created by a host and for performing a memory operation on a file data belonging to a data file;
STEP 512: Providing a set of file attributes for the data file;
STEP 514: Providing a plurality of predefined file data handling schemes;
STEP 566: Associating the set of file attributes with one of the plurality of predefined file data handling schemes, the schemes including a first scheme optimized for handling data files that are expected to be updated infrequently and associated with a file attribute having a first value (e.g., FILE_UPDATE_FREQ=“LOW”), the first scheme selecting a first block for operation, and a second scheme optimized for handling data files that are expect to be updated frequently and associated with a second value of the file attribute (e.g., FILE_UPDATE_FREQ=“HIGH”), the second scheme selecting a second block for operation;
STEP 570: Receiving a command for the memory system to perform a write operation on the file data;
STEP 572: Receiving the file data and its set of file attributes; STEP 574: Does the file attribute (e.g., FILE_UPDATE_FREQ) have the first value (e.g., “LOW_FREQ”) or the second value (e.g., “HIGH_FREQ”)? If it has the first value, proceed to STEP 580; if it has the second value, proceed to STEP 582.
STEP 580: Executing the command using the first scheme and operate on the first block.
STEP 582: Executing the command using the second scheme and operate on the second block.

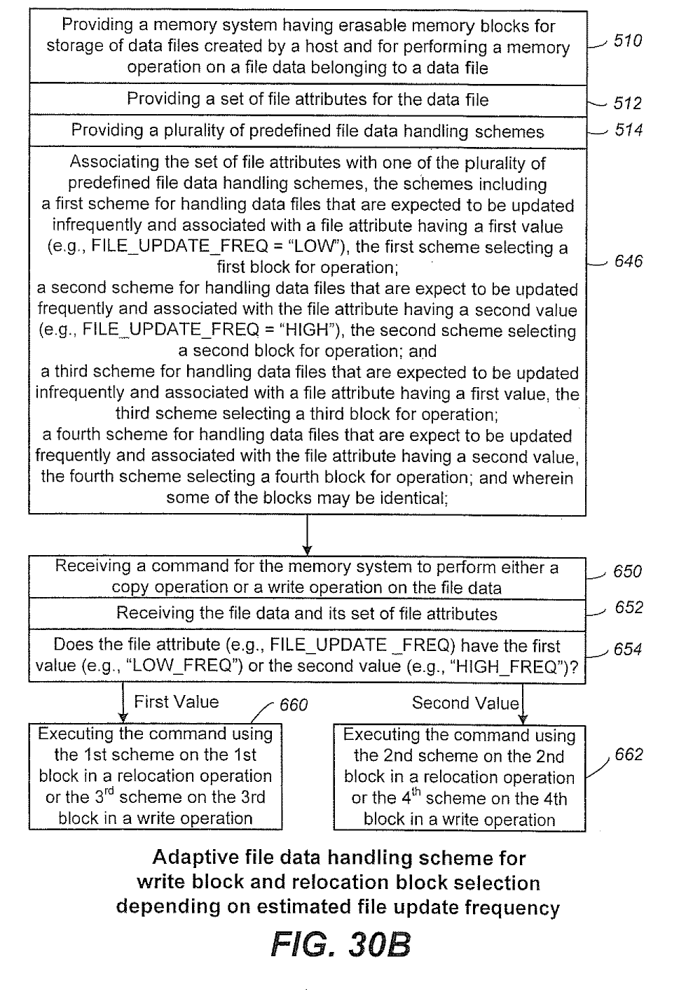

FIG. 30A illustrates the adaptive file data handling scheme for relocation block and write block selection depending on a file attribute indicating estimated file update frequency, according to a preferred embodiment of the present invention. Files (or data blocks) with different attributes can be copied from an obsolete block or written by a host to different relocation blocks or write blocks. FIG. 30A illustrates an example when a host writes data to an update block Block1 that eventually contains obsolete data. In a consolidation operation, valid data from the update block is copied to either one of two relocation blocks Block2 and Block3. At other times, the host writes data to another update block Block4 depending on file attributes.

In particular, in a series of host writes #1-#6, files A, B, C and different versions of file X are written to the update block Block1. The latest version X″ of file X will render all pervious versions, X and X′ obsolete. When Block1 has its valid data consolidated, files A, B, and C, and the latest version X″ of file X are copied to other blocks. The adaptive file data handling scheme directs the copying of the different files to different relocation blocks based on their file attributes. In this example, when writing files A, B and C interleaved with versions of file X to Block1, the system observes the access pattern of the various files and identifies that file X has a different access pattern compared to files A, B and C as it is not being stored for long time before being updated. Based on the difference in this file attribute, it is possible to distinguish file X from the more static files. Thus, it would be beneficial to handle further updated of file X differently by storing it in a different block, e.g., Block3 as compared to storing files A, B and C in Block2. In this way, separate blocks can be maintained for both files that are infrequently updated and those that are frequently updated.

Eventually, Block1 will need to be garbage collected by copying valid file data to the other blocks. Files with different attributes, which in this case is access pattern, can be copied to different relocation blocks. Files A, B and C will be copied to Bblock2, and file X″ will be copied to Block3.

In host write #7 and #9, the host writes files D and E respectively. The files are written to new block Block4 if the file type of file D is unclear; or to Block2 if the file type is the same as for files A, B and C; or to Block3 if type is the same as for X.

In host write #8, interleaved between host write #7 and #9, the host writes another new version X″′ of file X. Based on its file attribute being the same as file X it will be written to Block3 where previous versions reside.

Thus, different files are directed to different blocks based on their file attributes. Thus files of the same type are collected in the same type of blocks so that block management can be conducted with maximum efficiency.

FIG. 30B is a flow diagram illustrating the adaptive file data handling scheme depending on a file attribute indicating estimated file update frequency, according to a preferred embodiment of the present invention.

STEP 510: Providing a memory system having erasable memory blocks for storage of data files created by a host and for performing a memory operation on a file data belonging to a data file;
STEP 512: providing a set of file attributes for the data file;
STEP 514: Providing a plurality of predefined file data handling schemes;
STEP 646: Associating the set of file attributes with one of the plurality of predefined file data handling schemes, the schemes including
a first scheme for handling data files that are expected to be updated infrequently and associated with a file attribute having a first value (e.g., FILE_UPDATE_FREQ=“LOW”), the first scheme selecting a first block for operation;
a second scheme for handling data files that are expect to be updated frequently and associated with the file attribute having a second value (e.g., FILE_UPDATE_FREQ=“HIGH”), the second scheme selecting a second block for operation; and
a third scheme for handling data files that are expected to be updated infrequently and associated with a file attribute having a first value, the third scheme selecting a third block for operation;
a fourth scheme for handling data files that are expect to be updated frequently and associated with the file attribute having a second value, the fourth scheme selecting a fourth block for operation; and wherein some of the blocks may be identical (e.g., in FIG. 30A, Block3 is the same as the second and fourth block);
STEP 650: Receiving a command for the memory system to perform either a copy operation or a write operation on the file data;
STEP 652: Receiving the file data and its set of file attributes;
STEP 654: Does the file attribute (e.g., FILE_UPDATE_FREQ) have the first value (e.g., “LOW_FREQ”) or the second value (e.g., “HIGH_FREQ”)? If it has the first value, proceed to STEP 660; if it has the second value, proceed to STEP 662.
STEP 660: Executing the command using the first scheme on the first block in a relocation operation or the third scheme on the third block in a write operation.
STEP 662: Executing the command using the second scheme on the second block in a relocation operation or the fourth scheme on the fourth block in a write operation.

### CONCLUSION

Although the various aspects of the present invention have been described with respect to exemplary embodiments thereof, it will be understood that the present invention is entitled to protection within the full scope of the appended claims.

It is claimed:

1. In a memory system for storing data files created by a host, a method for performing a memory operation on file data belonging to a data file, comprising:
providing a set of file attributes for the data file;
providing a plurality of predefined file data handling schemes;
associating the set of file attributes with one of the plurality of predefined file data handling schemes;
receiving a file operating command to perform a memory operation on the file data;
selecting from the plurality of predefined file data handling schemes one associated with the set of file attributes for the data file to which the file data belongs; and
performing the memory operation on the file data by employing the selected predefined file data handling scheme.

2. The method as in claim 1, wherein the set of file attributes is obtained from the host.

3. The method as in claim 1, wherein the set of file attributes is obtained from the history of the data file with the memory system.

4. The method as in claim 1, wherein the set of file attributes includes a size for the data file and the associated predefined file data handling scheme is a scheme to pack file data among a set of one or more memory block during a write operation.

5. The method as in claim 1, wherein the set of file attributes includes an estimate for the frequency of file access for the data file and the associated predefined file data handling scheme is a scheme to direct file data selectively to a specific memory block during a relocation operation.

6. The method as in claim 1, wherein the set of file attributes includes a portion of the file name.

7. The method as in claim 1, wherein the set of file attributes includes an identification of the application that generated the data file.

8. The method as in claim 1, wherein the set of file attributes includes an identification of the host that provided the data file.

9. The method as in claim 1, wherein the set of file attributes includes a data modification performed on the file data either by the host or by the memory system.

10. The method as in claim 1, wherein the set of file attributes includes an update pattern detected previously by the memory system.

11. The method as in claim 1, wherein:
the memory operation includes writing file data; and
the predefined file data handling scheme is to write the file data of a new file into a new memory block when the set of file attributes includes a file size larger than that of a memory block, and to write the file data to an existing block following the file data of a last write when the set of file attributes includes a file size smaller than that of a memory block.

12. The method as in claim 1, wherein:
the memory operation includes a relocating file data; and
the predefined file data handling scheme is to write the file data selectively to a memory block containing data with similar file attributes.

13. The method as in claim 12, wherein:
the similar file attributes include an estimated file update frequency.

14. A memory system for storing data files created by a host, comprising:
an array of memory cells;
a memory controller for performing a memory operation on file data belonging to a data file created by a host;
a set of file attributes for the data file;
a plurality of predefined file data handling schemes;
an association between the set of file attributes with one of the plurality of predefined file data handling schemes; and
said memory controller in response to a file operating command to perform a memory operation on the file data selecting from the plurality of predefined file data handling schemes one associated with the set of file attributes for the data file to which the file data belongs and performing the memory operation on the file data by employing the selected predefined file data handling scheme.

15. A memory system as in claim 14, wherein the set of file attributes is obtained from the host.

16. The memory system as in claim 14, wherein the set of file attributes is obtained from the history of the data file with the memory system.

17. The memory system as in claim 14, wherein the set of file attributes includes a size for the data file and the associated predefined file data handling scheme is a scheme to pack file data among a set of one or more memory block during a write operation.

18. The memory system as in claim 14, wherein the set of file attributes includes an estimate for the frequency of file access for the data file and the associated predefined file data handling scheme is a scheme to direct file data selectively to a specific memory block during a relocation operation.

19. The memory system as in claim 14, wherein the set of file attributes includes a portion of the file name.

20. The memory system as in claim 14, wherein the set of file attributes includes an identification of the application that generated the data file.

21. The memory system as in claim 14, wherein the set of file attributes includes an identification of the host that provided the data file.

22. The memory system as in claim 14, wherein the set of file attributes includes a data modification performed on the file data either by the host or by the memory system.

23. The memory system as in claim 14, wherein the set of file attributes includes an update pattern detected previously by the memory system.

24. The memory system as in claim 14, wherein:
the memory operation includes writing file data; and
the predefined file data handling scheme is to write the file data of a new file into a new memory block when the set of file attributes includes a file size larger than that of a memory block, and to write the file data to an existing block following the file data of a last write when the set of file attributes includes a file size smaller than that of a memory block.

25. The memory system as in claim 14, wherein:
the memory operation includes a relocating file data; and
the predefined file data handling scheme is to write the file data selectively to a memory block containing data with similar file attributes.

26. The memory system as in claim 25, wherein:
the similar file attributes include an estimated file update frequency.
